(19) United States
(12) Patent Application Publication
(10) Pub. No.: US 2025/0020902 A1
(43) Pub. Date: Jan. 16, 2025

(54) LIGHT-FIELD MICROSCOPE WITH HYBRID POINT-SPREAD FUNCTION

(71) Applicant: GEORGIA TECH RESEARCH CORPORATION, Atlanta, GA (US)

(72) Inventors: Shu Jia, Johns Creek, GA (US); Wenhao Liu, Atlanta, GA (US)

(21) Appl. No.: 18/714,517

(22) PCT Filed: Dec. 2, 2022
(86) PCT No.: PCT/US2022/051696

§ 371 Date: May 29, 2024

Related U.S. Application Data
(60) Provisional application No. 63/285,583, filed on Dec. 3, 2021.

(51) Int. Cl. G02B 21/36; G02B 3/00; G02B 27/00

(52) U.S. Cl. CPC G02B 21/361; G02B 3/0056; G02B 21/367; G02B 27/0075

(57) ABSTRACT

A light-field microscopy system includes a light-field microscope, and an image processing system configured to receive images from the light-field microscope and perform a hybrid point-spread function (PSF) operation using a hybrid point-spread function that comprises numerical profiles that are adjusted by experimental positions acquired from an experimentally recorded PSF.

### CROSS REFERENCE TO RELATED APPLICATIONS

This application is a non-provisional of and claims priority benefit to U.S. Provisional Patent Application Ser. No. 63/285,583, filed Dec. 3, 2021, pending, which application is hereby incorporated by this reference in its entirety.

### STATEMENT REGARDING FEDERALLY SPONSORED RESEARCH OR DEVELOPMENT

This invention was made with government support under grant number R35GM124846 and grant number AI116482, awarded by the National Institutes of Health, and grant number EFMA1830941 awarded by the National Science Foundation. The government has certain rights in the invention.

### BACKGROUND

### Field

Embodiments of the present invention relate to light-field microscopes, specifically Light-Field Microscopes with Hybrid Point-Spread Function.

### Background

Organoids are stem cell-derived 3D multicellular in vitro tissue constructs that recapitulate the pertinent in vivo organs. These miniaturized and simplified model systems have a remarkable resemblance to the microscale tissue architectures and key functionalities of their in vivo counterparts, overcoming the barriers of classical cell line and animal model systems to understanding human biology and medicine. The recent advances of various organoid systems have demonstrated their great potential and promise in modeling tissue development and disease, high scalability and amenability to biomaterials and protocols, and in a wide range of applications in basic biology, drug discovery, and regenerative medicine.

Thorough exploitation of the promises of organoids requires a detailed picture of the cellular complexity modeled with organoids. Indeed, fluorescence microscopy has become a major driving force to probe this complexity—to reveal the phenotypic and functional states of organoid development and pathogenesis, gaining us critical insights relevant to their original organs. Unlike traditional tissue sectioning, organoids are generated in 3D matrices and thereby necessitate live, noninvasive observation to study fine cellular details within an intact tissue architecture in vitro. To address this need, one major consideration underlying live imaging of organoids lies in the balance between volumetric capability (e.g., the spatiotemporal resolution, signal-to-noise ratio (SNR), optical sectioning) and sample health (e.g., phototoxicity, photobleaching). Conventional wide-field systems, for instance, have difficulty visualizing 3D cultures with more than 2-3 cell layers due to the lack of optical sectioning. Major 3D fluorescence microscopy techniques such as confocal, multiphoton, and light-sheet fluorescence microscopy have thus far substantially transformed the study of complex 3D structures and processes of organoids at the cellular and subcellular levels. All these techniques have contributed to elegant 3D characterizations of fixed and cleared intact organoids. However, though confocal or multiphoton laser scanning techniques offer a high 3D resolution, they are time-consuming and may lead to increased photodamage, making the strategies less optimum for live imaging of large organoid samples.

By contrast, light-sheet microscopy provides effective optical sectioning without significant photobleaching and altered physiology of organoid specimens, thus becoming a valuable tool for the long-term investigation of live organoids. However, the light-sheet methods remain suboptimal in broad applicability, primarily due to the inadequate volumetric image throughput. Specifically, the underlying light-sheet scanning mechanism, augmented by potential tile stitching, inevitably entails a compromised volume time resolution, especially when capturing complete or multiple organoids ranging over hundreds of micrometers, leading to an unmet imaging gap for organoid study to capture fast cellular and tissue dynamic processes in a simultaneous, volumetric manner (e.g., collective cellular responses at sub-second time scales across whole organoids).

### BRIEF SUMMARY OF THE DISCLOSURE

Accordingly, the present invention is directed to Light-Field Microscope with a Hybrid Point-Spread Function that obviates one or more of the problems due to limitations and disadvantages of the related art.

In accordance with the purpose(s) of this invention, as embodied and broadly described herein, this invention, in one aspect, relates to a light-field microscopy system that includes a light-field microscope; and an image processing system configured to receive images from the light-field microscope and perform a hybrid point-spread function (PSF) operation using a hybrid point-spread function that comprises numerical profiles that is adjusted by experimental positions an experimentally recorded PSF.

In the light-field microscopy system, the experimentally recorded PSF may be obtained by imaging a first sample of size X (e.g., single-layer sparse sample, e.g., 2-μm fluorescent beads) across a depth range at least 10 times that of size X (e.g., ±40 μm).

The light-field microscope may comprise a Fourier light-field microscope.

The light-field microscope may include an epifluorescence microscopy unit comprising objective lens, tube lens, and camera; and a light-field acquisition module coupled to the epifluorescence microscopy unit, the light-field acquisition module comprising Fourier lens (FL) and microlens array (MLA).

The light-field microscope and image processing system may be optimized for organoid imaging. The light-field microscope and image processing system may be configured for millisecond-scale spatiotemporal characterization of a sample.

The light-field microscope and image processing system may be configured for millisecond-scale spatiotemporal characterization having an imaging span of between 900 μm×900 μm×200 μm in the x, y, and z axis, respectively.

The light-field microscopy system may include a motor-controlled mechanical loading module.

A method to process an image may include receiving images from a light-field microscope; performing a hybrid point-spread function (PSF) operation using a hybrid point-spread function that comprises numerical profiles that are adjusted by experimental positions and experimentally recorded PSF. The hybrid point-spread function may be generated by reconstructing an experimentally measured PSF; reconstructing a numerically simulated PSF; generating sub-PSF of the experimentally measured PSF by cropping image elements from the experimentally measured PSF; generating sub-PSF of the numerically simulated PSF by cropping image elements from the numerically simulated PSF; interpolating the sub-PSFs of the experimentally measured PSF and the numerically simulated PSF; fitting (i) positions of the sub-PSF of the experimentally measured PSF and (ii) positions of the sub-PSF of the numerically simulated PSF; and generating the hybrid point-spread function using the fitted positions.

A non-transitory computer-readable medium may have instructions stored thereon, wherein execution of the instructions by a processor causes the processor to perform any of the methods described herein.

A non-transitory computer-readable medium may have instructions stored thereon, wherein execution of the instructions by a processor causes the processor to perform operations for any of the systems described herein.

A method to process an image may include receiving images of an object from a first channel of a light-field microscope, the first channel carrying data corresponding to light of a first wavelength, and simultaneously receiving images of the object from a second channel of the light field microscope, the second channel carrying data corresponding to light of a second wavelength; applying a first hybrid point-spread function (PSF) operation to the data of the first channel using a hybrid point-spread function that comprises numerical profiles that are adjusted by experimental positions acquired from an experimentally recorded PSF; and applying a second hybrid point-spread function (PSF) operation to the data of the second channel using a hybrid point-spread function that comprises numerical profiles that is adjusted by experimental positions acquired from an experimentally recorded PSF.

In the method, the first hybrid point-spread function may be generated by interpolating the experimentally measured PSF and the numerically simulated PSF of the first channel; fitting (i) positions of the interpolated experimentally measured PSF and (ii) positions of the interpolated numerically simulated PSF of the first channel; generating sub-PSF of the interpolated numerically simulated PSF by cropping image elements from the numerically simulated PSF round the fitted positions of the first channel; generating the interpolated hybrid point-spread function by substituting the interpolated sub-PSF of the numerically simulated PSF into the interpolated experimental recorded PSF using the fitted positions of the first channel; and generating the hybrid point-spread function by binning the interpolated hybrid point-spread function of the first channel; and the second hybrid point-spread function may be generated by interpolating the experimentally measured PSF and the numerically simulated PSF of the second channel; fitting (i) positions of the interpolated experimentally measured PSF and (ii) positions of the interpolated numerically simulated PSF of the second channel; generating sub-PSF of the interpolated numerically simulated PSF by cropping image elements from the numerically simulated PSF round the fitted positions of the second channel; generating the interpolated hybrid point-spread function by substituting the interpolated sub-PSF of the numerically simulated PSF into the interpolated experimental recorded PSF using the fitted positions of the second channel; and generating the hybrid point-spread function by binning the interpolated hybrid point-spread function of the second channel.

In the method, the first channel may correspond to a first color, and the second channel corresponds to a second color. In the method, the first wavelength and the second wavelength may be produced by passing light from the object through a microfilter array comprising an array of microfilters, wherein a first number of microfilters in the microfilter array correspond to the first wavelength and a second number of microfilters in the microfilter array correspond to the second wavelength. A non-transitory computer-readable medium may have instructions stored thereon, wherein execution of the instructions by a processor causes the processor to perform the methods described herein.

A system for processing images in microscopy may include a memory comprising executable instructions; a processor configured to execute the executable instructions and cause the system to perform the method described herein.

### BRIEF DESCRIPTION OF THE DRAWINGS

The accompanying figures, which are incorporated herein and form part of the specification, illustrate Light-Field Microscope with Hybrid Point-Spread Function. Together with the description, the figures further serve to explain the principles of the Light-Field Microscope with Hybrid Point-Spread Function described herein and thereby enable a person skilled in the pertinent art to make and use the Light-Field Microscope with Hybrid Point-Spread Function.

Fourier light-field microscopy is disclosed using a hybrid point-spread function (hPSF-FLFM) for fast, volumetric, and high-resolution imaging of biological systems. hPSF-FLFM can be employed to transform conventional 3D microscopy (and custom microscopy images) and enables exploration of less accessible spatiotemporally-challenging regimes for biological research. The system can be used for cellular (e.g., 2-3 μm and 5-6 μm in x-y and z, respectively) and millisecond-scale spatiotemporal characterization of whole-organoid dynamic changes that span large imaging volumes (>900 μm×900 μm×200 μm in x, y, z, respectively). The hPSI-FLFM method provides a promising avenue to explore spatiotemporal-challenging cellular responses in a wide variety of organoid research.

Biological systems can include cellular and/or tissue of plants or animals, including embryonic stem cells or induced pluripotent stem cells.

Biological systems can include organoids such as thyroid organoid, thymic organoid, testicular organoid, prostate organoid, hepatic organoid, pancreatic organoid, epithelial organoid, lung organoid, kidney organoid, gastruloid (embryonic organoid), blastoid (blastocyst-like organoid), cardiac organoid, retinal organoid, glioblastoma organoid, among others.

FIG. 1 includes subparts (a)-(l) showing various point spread functions. FIG. 1(a) shows a numerically simulated point spread function. FIG. 1(b) shows experimentally measured PSF. FIGS. 1(c)-(d) shows zoomed-in images of the PSFs cropped from FIGS. 1(a) and 1(b) respectively. FIGS. 1(e)-(h) show PSF images on each layer were interpolated. FIGS. 1(i)-(k) show corresponding lateral shifts of the corresponding numerical and experimental PSFs were compared and merged. FIG. 1(l) shows a final hybrid PSF using numerical profiles and experimental positions.

FIG. 2 includes subparts (a)-(f). FIG. 2(a) is a schematic of the experimental setup according to the principles described herein. FIG. 2(b) is an axial stack projection (step size=400 nm) of the hybrid point-spread function (hPSF) through the 3×3 microlenses. FIG. 2(c) is a raw light-field image of a fluorescent sector star and the corresponding synthesized focal image. FIG. 2(d) is a 3D reconstructed light-field image in x-y, x-z, and y-z views of 2-μm fluorescent beads distributed in 3D agarose gel. FIG. 2(e) shows wide-field images of the same volume. FIGS. 2(f) and (g) are zoomed-in x-y, x-z, and y-z images. FIG. 2(f) is a zoomed-in view of the boxed region in FIG. 2(d) and their corresponding cross-sectional profiles are shown in FIG. 2(g).

FIG. 3 includes subparts (a)-(j). FIG. 3(a) shows an overall setup of the prototype. FIG. 3(b) is an overlook of the Fourier light-field path. FIG. 3(c) of the microlens array (MLA) design. FIG. 3(d) is a photo of the wide-field path. FIG. 3(e) is a photo of a 3D printed mount for the 50:50 cubic beam splitter. FIG. 3(f) is a photo of an illumination part. FIG. 3(g) is a sample stage used for the prototype. FIG. 3(h) is a schematic of the setup. FIG. 3(i) is a schematic of the light-field acquisition. FIG. 3(j) shows ray tracing of the light with respect to the experimental prototype.

FIG. 4 includes subparts (a)-(d), which illustrate various aspects of an experimental set up according to the principles described herein.

FIG. 5 includes subparts (a)-(n). FIG. 5(a) is a raw light-field image/FIG. 5(b) is a 3D reconstructed hPSF-FLFM. FIG. 5(c) is the same hPSF-FLFM organoid image taken at t=90 s. FIGS. 5(d)-(i) shows Time-lapse hPSF-FLFM images of the organoid at t=0, 29.6, 44.7, 59.8, 74.9, and 90.0 s, respectively. FIG. 5(j) shows volume variation over >1-min period after osmotic stress was induced during t=1-5 s. FIG. 5(k) is a volumetric rendering of the boxed region in FIG. 5(d). FIG. 5(l) shows x-y, y-z, and x-z views of the volume at time points t=0, 29.6, 44.7, 59.8, 74.9, 90.0 s. FIG. 5(m) shows the 3D trajectories of five cells marked by the white squares in FIG. 5(l). FIG. 5(n) shows corresponding displacements of the five cells over the time period between 29.6 and 90 s.

FIG. 6 includes subparts (a)-(r). FIG. 6(a) is a photo, and FIG. 6(b) is a schematic of the motor-controlled mechanical loading module. FIG. 6(c) is a diagram for mechanical loading and uploading distance by the motor. FIG. 6(d) is a 3D reconstructed hPSF-FLFM image, and FIG. 6(e) is a MIP image of a hCO at 1=2.7 s. FIGS. 6(f) and (g) show synthesized hPSF-FLFM x-y focal image at z=14.8 μm and corresponding x-z and y-z cross-sectional views along the lines at 1=2.7 s (FIGS. 6(f)) and 7.1 s (FIG. 6(g)). FIGS. 6(h)-(k) illustrate the spatiotemporal resolution and volumetric ability of the system. FIGS. 6(l)-(p) illustrate spatiotemporal characterizations of individual cells leading to the 3D mapping of the velocity variations upon mechanical perturbation. FIGS. 6(i), (q) and (r) illustrate displacement, correlation, and eccentricity, respectively, over time.

FIG. 7 illustrates iterative design parameters according to the principles described herein.

FIG. 8 includes subparts (a) and (b). FIG. 8(a) is the same as FIG. 2(b). FIG. 8(b) is a cross-sectional profile of the central hPSF element.

FIG. 9 includes subparts (a)-(l). FIGS. 9(a)-(f) illustrates the generation of a hybrid point-spread function (hPSF). FIG. 9(a) shows numerically simulated PSF. FIG. 9(b) shows experimentally measured PSF. FIGS. 9(c) and (d) are zoomed-in images of the PSFs cropped from a and b, respectively. FIGS. 9(e)-(h) are PSF images on each layer that were interpolated. FIGS. 9(i)-(k) show corresponding lateral shifts of the corresponding numerical and experimental PSFs were compared and merged. FIG. 9(l) shows the final hybrid PSF using the numerical profiles and experimental positions.

FIG. 10 includes subparts (a)-(t). FIGS. 10(a), (e), (m) are raw light-field fluorescent images of a sector star, a USAF 1951 pattern, and a 10-μm mesh grid, respectively. FIGS. 10(b), (f), (n) are central elemental images cropped out from FIGS. 10(a), (e), (m), respectively. FIGS. 10(c), (g), and (o) are synthesized focal images of the reconstructed volumes from FIGS. 10(a), (e), (m), respectively. FIGS. 10(d), (h), (p) show corresponding wide-field images with respect to FIGS. 10(a), (e), (m). FIGS. 10(i) and (k) are zoomed-in images of the boxed regions, respectively, in FIGS. 10(f) and (g). FIGS. 10(j) and (l) are cross-sectional intensity profiles. FIG. 10(q) is a zoomed-in image of the 10-μm mesh grid from FIGS. 10(p). FIG. 10(r) is a cross-sectional intensity profile along the dashed line in FIG. 10(q). FIG. 10(s) is a linear fitted line of the coordinates of the peaks of FIG. 10(r) in the unit of pixels. FIG. 10(t) shows the linear fitting of the magnification on different layers as in s over a depth range of ±40 μm at a step size of 1 μm.

FIG. 11 shows a raw Fourier light-field image of the volumetric beads shown in FIG. 2(d).

FIG. 12 includes subparts (a)-(i). FIG. 12(a) shows raw light-field imaging. FIG. 12(b) show a 3D reconstructed hPSF-FLFM image. FIG. 12(c) is a wide-field image of the same area as shown in FIG. 12(b) FIGS. 12(d) and (g) are zoomed-in images of the corresponding boxed regions in b. FIGS. 12(e) and (h) are zoomed-in images of the corresponding boxed regions FIGS. 12(d) and (g). FIGS. 12(f) and (i) are cross-sectional intensity profiles along the corresponding dashed lines in FIGS. 12(e) and (h), respectively, showing well-resolved subcellular filamentary structures. Scale bars are 250 μm (FIG. 12(a)), 100 μm (FIGS. 12(b), (c)), 20 μm (FIGS. 12(d) and (g)), 5 μm (FIGS. 12(e) and (h)).

FIG. 13 shows wide-field images of the bovine pulmonary artery endothelial (BPAE) cells as shown in FIG. 12.

FIG. 14 includes subparts (a)-(u). FIG. 14 shows a comparison of volumetric reconstruction using the numerical, experimental, and hybrid PSFs. The left panels of FIGS. 14(a)-(d) show reconstruction of a USAF 1951 target using numerically simulated PSF (FIG. 14(a)), experimentally recorded PSF (FIG. 14(b)), the hybrid PSF (FIG. 14(c)), and the wide-field image of the target (FIG. 14(d)). Corresponding right panels show cross-sectional intensity profiles along the dashed lines, showing the resolution of 2.2-μm structures in Group 7 of the target using the hPSF. FIGS. 14(e)-(j) show reconstructed x-y, x-z, y-z images and their corresponding cross-sectional profiles of the 2-μm bead as measured in FIGS. 2(f) and (g) using numerical and experimental PSFs, indicating improved reconstruction with the hPSF, especially in the axial dimension. FIGS. 14(k)-(r) show the reconstruction of the BPAE cells as in FIG. 12, indicating potential artifacts and missing information using the numerical or experimental PSFs. FIGS. 14(s)-(u) are 3D reconstructed MIP images of human colon organoids stained with Syto 16 in the nucleus using numerical, experimental, and hybrid PSFs, respectively.

FIG. 15 includes subparts (a)-(n). FIG. 15(a) shows a raw light-field image and FIG. 15(b) shows a 3D reconstructed hPSF-FLFM image of hCOs stained in the nucleus with Syto 16 and taken at an exposure time of 0.1 s. FIG. 15(c) is a set of scanning wide-field MIP images of the same organoid, acquired by overlaying 202 axial stacks at a step size of 400 nm. FIG. 15(d) are synthesized light-field images that show consistent cellular structures and enhanced optical sectioning and contrast throughout an 80-μm depth range in comparison with widefield stack images. FIG. 15(f) is a raw light-field image, and FIG. 15(f) is a 3D reconstructed hPSF-FLFM image. FIG. 15(g) is an image exhibiting a prominent hollow lumen of hCOs in all three dimensions (insets). FIG. 15 (h) is a set of zoomed-in images of the boxed volume in FIG. 15(g), showing well-resolved 3D individual nucleic structures separated as close as 3.65 μm. FIG. 15(i) is a central element of the raw 3×3 light-field images of multiple hCOs captured in one camera frame. FIG. 15(j) is a 3D reconstructed hPSF-FLFM image of a budded organoid. FIGS. 15 (k) and (l) are zoomed-in images of the boxed crypts (FIG. 15(k), x-y) and along the yellow line (FIG. 15(l), x-z) in FIG. 15(j), displaying a thin epithelial lining separating the lumen from the outer environment. FIGS. 15 (m) and (n) are cross-sectional profiles along the red dashed lines in FIGS. 15 (k) and (l), respectively, resolving epithelial cellular structures at a few micrometers in all three dimensions.

FIG. 16 includes subparts (a)-(l). FIG. 16 shows additional results on the light-field and 3D reconstructed images of human colon organoids.

FIG. 17 includes subparts (a)-(e). FIG. 17 shows additional results on observation of human colon organoids under osmotic stress over 130 s at the volumetric acquisition time=10 ms. FIG. 17(a) is a raw light-field image of the organoid. FIGS. 17(b) and (c) show 3D reconstructed volume. FIG. 17(d) is a zoomed-in 3D MIP image of the boxed volume in FIG. 17(c). FIG. 17(e) is a zoomed-in 3D MIP images of the boxed volume in FIG. 17(d). Color squares in FIGS. 17(d) and (e) mark the cells selected for tracking over time. FIG. 17(f) shoes 3D displacements (gray curves) of the cells as marked in FIG. 17(d), the black curve shows the average movement. FIG. 17(g) shows cross-sectional area change in all three dimensions, exhibiting volumetric compression due to osmotic stress. Scale bars: 150 μm (FIG. 17(a)), 50 μm (FIGS. 17(b) and (c)), 20 μm (FIG. 17(d)), 2 μm (FIG. 17(e)).

FIG. 18 includes subparts (a)-(c). FIG. 18 shows additional results on cell tracking as shown in FIG. 6(k). FIG. 18(a) shows a depth-coded x-y MIP image of the entire reconstructed volume of the whole organoid as in FIG. 6(e). FIG. 18(b) is a zoomed-in image in x-y, x-z, y-z, and depth-coded views of the boxed region in FIG. 18(a) at t=2.7, 5.5, 7.1, 10.0, 38.75 s. FIG. 18(c) shows displacements of the selected cells as in FIG. 6(k) over time.

FIG. 19 shows an illustrative computer architecture for a computer system capable of executing the software components that can use the output of the exemplary method described herein.

### DETAILED DESCRIPTION

Reference will now be made in detail to embodiments of the illustrated Light-Field Microscope with Hybrid Point-Spread Function with reference to the accompanying figures The same reference numbers in different drawings may identify the same or similar elements.

It will be apparent to those skilled in the art that various modifications and variations can be made in the present invention without departing from the spirit or scope of the invention. Thus, it is intended that the present invention cover the modifications and variations of this invention, provided they come within the scope of the appended claims and their equivalents.

An hPSF-FLFM, a light-field microscopy system, is disclosed using hybrid point-spread functions for fast, volumetric, and high-resolution imaging of entire organoids. Unlike conventional 3D organoid microscopy methods, hPSF-FLFM offers scanning-free, snapshot recording with a cellular, milliseconds spatiotemporal resolution of near-millimeter-level whole-mount organoids. In particular, it has been validated that the hPSF strategy can facilitate the 3D characterization of cellular dynamic processes of whole organoids in response to rapid extracellular physical cues, including the osmotic and mechanical stresses.

The observed results have overcome the limitation of the instantaneous recording of rapid cellular details throughout the organoid volume using conventional imaging methods. It is anticipated that the light-field strategy can provide a new avenue for fast and long-term organoid observation with minimum photodamage per volumetric acquisition compared to existing techniques. Furthermore, as the hPSF-FLFM system is fully adaptable to standard epifluorescence protocols, the design and instrumentation are cost-efficient and highly scalable. Combining versatile optical and computational strategies, it is contemplated that hPSF-FLFM can be employed for organoid and in vivo organ research.

A first example hPSF was generated and processed for reconstruction as described below.

FLFM is a linear system that projects and compresses a 3D objective volume onto a 2D camera chip. The 2D intensity image I_{c}(ρ_{c}) taken by FLFM thus can be described as the convolution of the intensity distribution I₀(rₒ) of the isotropic emitters in the objective space and the (point spread function) PSF PSF(rₒ, ρ_{c}) of the FLFM system, which is the square of the real part of the wave function U(rₒ, ρ_{c}) of the FLFM system:

$${I}_{c} ( {ρ}_{c} ) = \int PSF ( {r}_{o} , {ρ}_{c} ) {I}_{o} ( {r}_{o} ) {dr}_{0} = \int {\vert Re [ U ( {r}_{o} , {ρ}_{c} ) ] \vert}^{2} {I}_{o} ( {r}_{o} ) {dr}_{o} \qquad ( S16 )$$

where rₒ=(x₀, y₀, z₀)∈ [symbol] is the radius vector of the fluorescent emitters in objective space and ρ_{c}=(x_{c}, y_{c})∈ [symbol] gives the positions of pixels on the sensor plane. In practical calculation, both the objective volume and the sensor plane are discretized so that the relationship between the camera image I₀ and the fluorescent intensity field I_{c} of the sample can be described as the product of matrix, I_{c}=HI₀, where H is the measurement matrix which is determined by the PSF and whose elements h_{j,k}=PSF(rₒⱼ, ρ_{ck}) denotes the contribution from the kth voxel in the objective domain to the intensity on the jth pixel on the camera sensor. Therefore, the reconstruction is mathematically an inverse process to recover I from a given I, and a maximum likelihood estimation can be gained by a modified deconvolution algorithm based on the Richardson-Lucy iteration scheme [1′,2′]:

$${I}_{o}^{k + 1} = diag \{ diag {\{ {H}^{T} {HI}_{o}^{( k )} \}}^{- 1} ( {H}^{T} {I}_{c} ) \} {g}^{( k )} \qquad ( S17 )$$

where the operator diag{ } diagonalizes a matrix. Therefore, the key point in retrieving the sample information from a raw light-field image via deconvolution is to acquire the PSF of the FLFM system.

Hybrid PSF generation. In the reconstruction via deconvolution, either an experimental measured or numerical simulated PSF can be used. The experimental PSF faithfully records the deviation of PSF caused by the misalignment of the system and its difference from a theoretical PSF due to the limited accuracy of the fabrication of the MLA. However, the information of the details of the PSF is usually lost in the inevitable image noise, especially in greater depths, rendering artifacts in the reconstructed volume. On the other hand, the simulated PSF in single or double precision is free of noise and overcomes the continuity of the intensity value that challenges the experimental PSF recorded by an sCMOS camera. However, it contains no information about the mismatch between the MLA used in practice and the theoretically simulated phase mask, causing artifacts or deviated information in the reconstruction. Here, we here used a hybrid PSF generated by calibrating the positions of elemental images in the simulated PSF with an experimentally recorded PSF. The experimental PSF was obtained by imaging single-layer sparse 2-μm fluorescent beads across a depth range of ±40 μm, which profiles were then replaced by the numerical results.

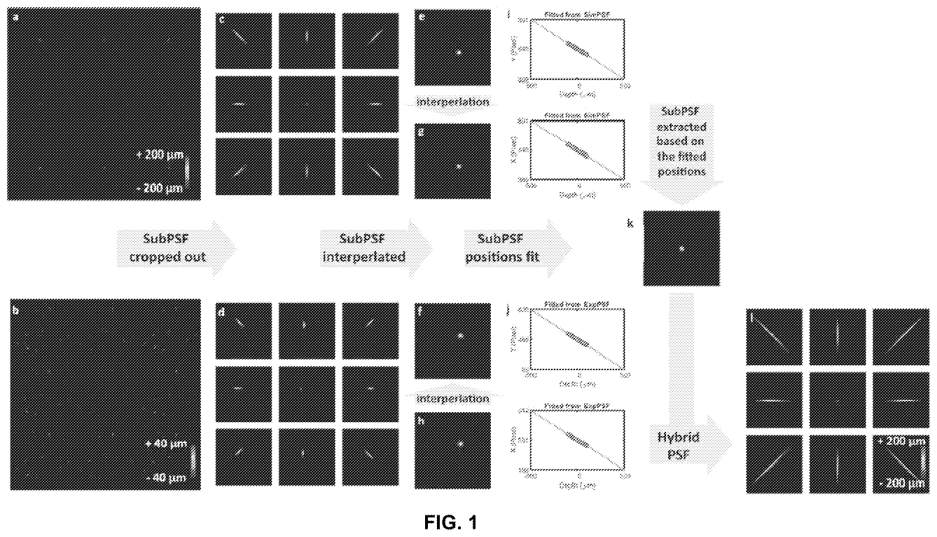

The detailed procedure is illustrated below in FIG. 1. FIG. 1(a) shows a numerically simulated point spread function. FIG. 1(b) shows experimentally measured PSF. FIGS. 1(c)-(d) shows zoomed-in images of the PSFs cropped from FIGS. 1(a) and 1(b) respectively. FIGS. 1(e)-(h) show PSF images on each layer were interpolated. FIGS. 1(i)-(k) show corresponding lateral shifts of the corresponding numerical and experimental PSFs were compared and merged. FIG. 1(l) shows a final hybrid PSF using numerical profiles and experimental positions.

Derivation of wave function from a wave-optics model. To gain the PSF, the wave function U (ro, ρNAT) of a point emitter is at first calculated on the native image plane (NIP) via Debye theory, considering a high numerical aperture (NA) objective is used [3 (Gu, M. Advanced optical imaging theory (2010))]:

$$U ( {r}_{o} , {ρ}_{NAT} ) = \frac{{M}_{obj}}{{f}_{obj}^{2} {λ}^{2}} exp [ - \frac{iu}{4 {sin}^{2} ( α / 2 )} ] {\int }_{0}^{α} P ( θ ) exp [ \frac{iu {sin}^{2} ( θ / 2 )}{2 {sin}^{2} ( α / 2 )} ] {J}_{0} [ \frac{sin ( θ )}{sin ( α )} ] sin ( θ ) d θ \qquad ( S18 )$$

where ρ_{NAT}=(xₙ, yₙ) represents the x and y coordinates on NIP, f_{obj} and M being respectively the focal length and magnification of the objective, and J₀ is the zeroth order Bessel function of the first kind. The variable v denotes normalized radial coordinate, defined as v=k[(x₀−xₙ)²+(y₀−yₙ)²]¹^{^{/2}}sin(α), while u denotes normalized axial optical coordinates, defined as u=4kz₀ sin(α/2). The half-angle of the numerical aperture α=sin⁻¹(NA/n) and the wave number k=2πn/λ are calculated using the wavelength λ and the index of refraction n of the sample. For Abbe-sine corrected objectives, the apodization function of the microscope P(θ)=cos(θ)^{1/2} in this case. In our setup, f_{obj} is 12.5 mm, M is 16, and λ peaks at 525 nm. The refractive index n is 1.33 for a water solution.

Secondly, the propagation of the wavefunction U(rₒ, ρ_{NAT}) onto the camera plane can be simulated by successively transforming U(rₒ, ρ_{NAT}) into its Fourier space, as [symbol] [U(rₒ, ρ_{NAT})], timing [symbol] [U(rₒ, ρ_{NAT})] by a phase mask Φ, which represents the modulation of the MLA, and finally projecting the result [symbol] [U(rₒ, ρ_{NAT})]Φ onto the sensor plane using optical Fourier transformation [4′] (Delen, N. & Hooker, JOSA. 1998):

$$U ( {r}_{o} , {ρ}_{c} ) = {ℱ}^{- 1} \{ \begin{matrix}ℱ [ ℱ [ U ( {r}_{o} , {ρ}_{NAT} ) ] Φ ( {ρ}_{μ} ) ] \times \\ exp [ i 2 π {f}_{MLA} \sqrt{{( \frac{1}{λ} )}^{2} - ( {f}_{x}^{2} + {f}_{y}^{2} )} ]\end{matrix} \} \qquad ( S19 )$$

in which the exponential term is the transfer function of the Fresnel diffraction integral, and fₓ and f_{y} are the x and y spatial frequencies in the sensor plane. Φ(ρ_{μ}) is the phase modulation function at the point ρμ=(ρ_{μx}, ρ_{μy})∈ [symbol] on the MLA. As the modulation of the entire lens array, it can be described by the convolution of a limited 2D comb function comb(ρ_{μ}/d₁) with the phase modulation function of a single lenslet, which is a combination of an input rectangular amplitude mask rect(ρ_{μ}/d₁) , a phase

$$exp ( \frac{- ik}{2 {f}_{MLA}} {‖ {ρ}_{μ} ‖}_{2}^{2} ) ,$$

and an output spherical amplitude mask circ(ρ_{μ}/d_{MLA}) :

$$Φ ( {ρ}_{μ} ) = comb ( \frac{{ρ}_{μ}}{{d}_{1}} ) ⊗ [ rect ( \frac{{ρ}_{μ}}{{d}_{1}} ) exp ( \frac{- ik}{2 {f}_{MLA}} {‖ {ρ}_{μ} ‖}_{2}^{2} ) circ ( \frac{{ρ}_{μ}}{{d}_{MLA}} ) ] \qquad ( S20 )$$

where f_{MLA}=30 mm, d_{MLA}=1.3 mm are, respectively, the focal length, and the diameter (aperture) of a single lens, while d₁=3.3 mm is the pitch of the MLA. The symbol ⊗ denotes the convolution operator.

Reconstruction based on Richard-Lucy deconvolution scheme. The 3D deconvolution expressed by Equation S17 iteratively conducts a forward projection (HIₒ^{(k)}) which projects the 3D object space onto the 2D camera plane and a backward projection (H^{T}I_{c} and H^{T}HIₒ^{(k)}) which takes the inverse process. As an FLFM system is spatially-invariant, PSF at a depth of z can be described as the intensity contribution from an emitter located on the optical axis, i.e., rₒ=(0, 0, z₀). As a result, the forward projection can be simplified as a sum of 2D convolution on different layers within an axial range [z−, z+], i.e.,

$${HI}_{o}^{( k )} = {\sum }_{{z}_{o} = {z}_{-}}^{{z}_{o} = {z}_{+}} PSF ( {ρ}_{c} , {z}_{o} ) ⊗ {I}_{o}^{( k )} ( {z}_{o} ) \qquad ( S21 )$$

where Iₒ^{(k)}(zₒ) represents the intensity distribution given by the single layer objects at the depth of z₀. Similarly, the simplified back projection form is given as:

$$\begin{matrix}{H}^{T} {I}_{c} ( {z}_{o} ) = {\sum }_{{z}_{o} = {z}_{-}}^{{z}_{o} = {z}_{+}} {PSF}^{′} ( {ρ}_{c} , {z}_{o} ) ⊗ {I}_{c} ( {z}_{o} ) & ( S22 ) \\ {H}^{T} {HI}_{o}^{( k )} ( {z}_{o} ) = {\sum }_{{z}_{o} = {z}_{-}}^{{z}_{o} = {z}_{+}} {PSF}^{′} ( {ρ}_{c} , {z}_{o} ) ⊗ {HI}_{o}^{( k )} ( {z}_{o} ) & ( S 23 )\end{matrix}$$

where PSF′(ρ_{c}, z₀) is obtained by rotating PSF (ρ_{c}, z₀) by 180 degrees. When processing data, the system sampled the objective space with an axial interval similar to the lateral sampling of the counterpart wide-field microscope, as Δ_{z}=400 nm, and a lateral interval same as the effective pixel size of FLFM, as Δ_{xy}=1806 nm, while the system further interpolated the reconstructed volume to increase the lateral sampling pixel size to 406 nm so that a near isotropic reconstructed volume can be obtained for easy visualization.

Hybrid PSF generation. In the reconstruction via deconvolution, either an experimental measured or numerical simulated PSF can be used. The experimental PSF faithfully records the deviation of PSF caused by the misalignment of the system and its difference from a theoretical PSF due to the limited accuracy of the fabrication of the MLA. However, the information of the details of the PSF is usually lost in the inevitable image noise, especially in greater depths, rendering artifacts in the reconstructed volume. On the other hand, the simulated PSF in single or double precision is free of noise and overcomes the continuity of the intensity value that challenges the experimental PSF recorded by an sCMOS camera. However, it contains no information about the mismatch between the MLA used in practice and the theoretically simulated phase mask, causing artifacts or deviated information in the reconstruction. Here, the system used a hybrid PSF generated by calibrating the positions of elemental images in the simulated PSF with an experimentally recorded PSF. The experimental PSF was obtained by imaging single-layer sparse 2-μm fluorescent beads across a depth range of ±40 μm, which profiles were then replaced by the numerical results.

### Example Fourier Light-Field Microscopy

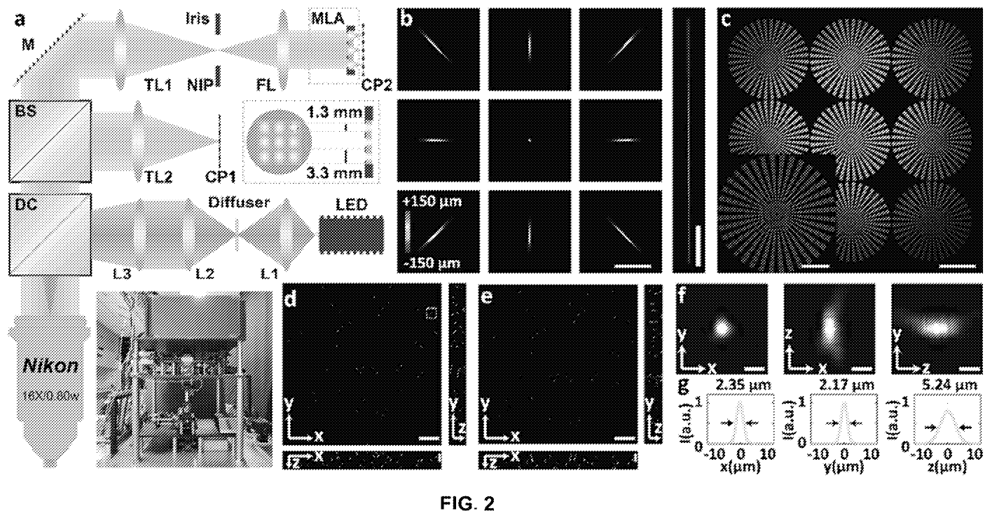

FIG. 2 shows an example Fourier light-field microscopy with a hybrid point-spread function.

FIG. 2(a) is a schematic of the experimental setup. LED, light-emitting diode; BS, beam splitter; DC, dichroic cube; M, mirror; TL, tube lens; NIP, native image plane; FL, Fourier lens; CP, camera plane; MLA, microlens array. The top inset displays the 3×3 MLA with the pitch d₁=3.30 mm and aperture d_{MLA}=1.30 mm. The bottom inset shows a photo of the custom-built system.

FIG. 2(b) is an axial stack projection (step size=400 nm) of the hybrid point-spread function (hPSF) through the 3×3 microlenses within an axial range from −150 μm to 150 μm, as color-coded in the color scale bar. The inset exhibits an in-depth view of the PSF element of the central microlens. FIG. 2(c) is a raw light-field image of a fluorescent sector star (physical diameter=893 μm) and the corresponding synthesized focal image (inset). FIG. 2(d) is a 3D reconstructed light-field image in x-y, x-z, and y-z views of 2-μm fluorescent beads distributed in 3D agarose gel of ˜900 μm×900 μm×90 μm. FIG. 2(e) shows wide-field images of the same volume, acquired by overlaying 91 axial stacks at a step size of 1 μm, showing consistent sample structure while less compact axial profiles at each depth. FIGS. 2(f) and (g) are zoomed-in x-y, x-z, and y-z images. FIG. 2(f) is a zoomed-in view of the boxed region in FIG. 2(d) and their corresponding cross-sectional profiles are shown in FIG. 2(g), exhibiting the FWHM values of 2.35 μm in x, 2.17 μm in y, and 5.24 μm in z. Scale bars: 100 μm (FIG. 2 (b)), 400 μm (FIG. 2 (c)), 200 μm (FIG. 2(c) inset), 100 μm FIGS. 2(d) and (e)), 40 μm (FIGS. 2(d) (e) insets), 10 μm (FIG. 2 (f)).

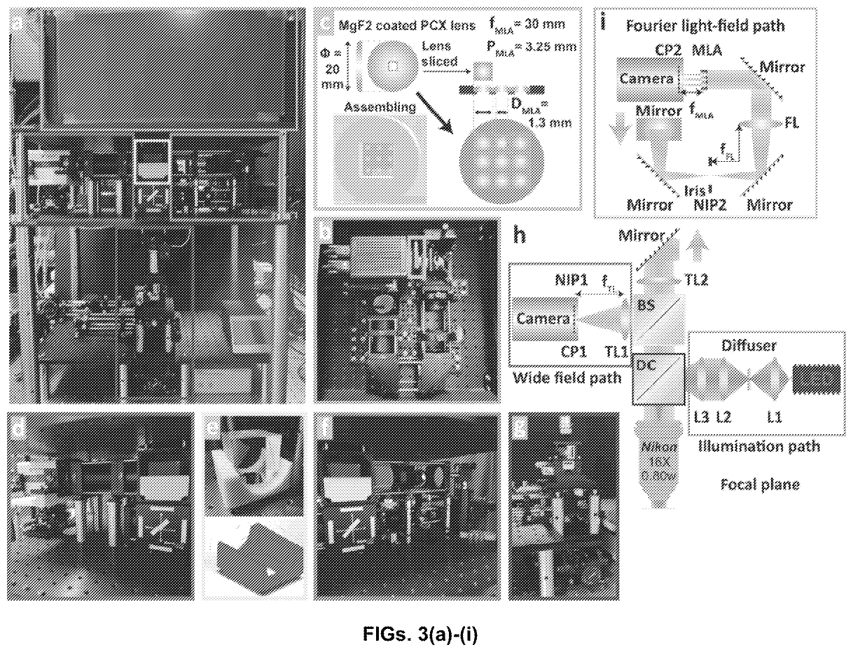

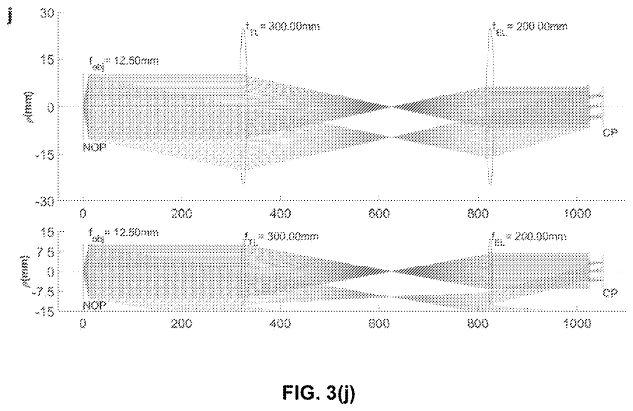

Light-field imaging system. FIG. 3 shows a prototype construction of an hPSI-FLFM system as described herein. In brief, the custom-built light-field system was constructed using a 16× objective (CFI75 LWD 16XW 16×, 0.8 NA, Nikon). The sample stage consists of three traveling stages (XYT1, Thorlabs; L490, Thorlabs; HLD-60 LM, Hengyang), and the objective lens is controlled by a nano-positioning system (Nano-F100S, MCL). A light-emitting diode (LED) with peak emission at 470 nm is used as the light source (M470L4, Thorlabs). The excitation light was filtered by an excitation filter (MF469-35, Thorlabs), and the fluorescence emission was collected using a 3D-printed dichroic cube containing a customized 72 mm×50.8 mm×2 mm dichroic mirror (T495lpxru, Chroma). The fluorescence emission was separated by a 50:50 cubic beam splitter (BS013, Thorlabs) into wide-field and Fourier light-field paths. In the wide-field path, the imaged was filtered by an emission filter (MF525-39, Thorlabs) and focused by a tube lens (TTL200-A, Thorlabs) on its back focal plane, where a scientific complementary metal-oxide-semiconductor (sCMOS) camera (Zyla 4.2, Andor; pixel size, 6.5 μm) was placed. In the Fourier light-field path, both the tube lens (TL, AC508-300-A, Thorlabs; f_{TL}=300 mm) and the Fourier lens (FL, AC508-300-A, Thorlabs; f_{FL}=200 mm) were achromatic lenses with a 50-mm aperture. The microlens array (MLA) used in the Fourier light-field path consisted of 9 square lenses fabricated from 9 plano-convex lenses (45-240, Edmund Optics), which were assembled into a 3D-printed mount (FIG. 3) and implemented onto a five-axis kinematic mount (K5X1, Thorlabs) for alignment. The image area was restrained by an iris (LCP50S, Thorlabs) to 900 μm to mitigate crosstalk, and the elemental images generated in the Fourier light-field path were filtered by an emission filter (ET525/30 m, Chroma) recorded by another sCMOS camera (ORCA-Flash4.0 V3, Hamamatsu; pixel size P=6.5 μm).

FIG. 3(a) shows an overall setup of the prototype. FIG. 3(b) is an overlook of the Fourier light-field path. FIG. 3(c) of the microlens array (MLA) design. FIG. 3(d) is a photo of the wide-field path. FIG. 3(e) is a photo of a 3D printed mount for the 50:50 cubic beam splitter. FIG. 3(f) is a photo of an illumination part. FIG. 3(g) is a sample stage used for the prototype. FIG. 3(h) is a schematic of the setup. FIG. 3(i) is a schematic of the light-field acquisition. CP, camera plane; TL, tube lens; DC, diachronic cube; BS, beam splitter; L1, L2, L3, lens to homogenize and focus the LED light onto the back focal plane of the objective lens; FL, Fourier lens; NIP, native image plane; f_{TL}, focal length of the corresponding tube lens; fFL, focal length of the Fourier lens; f_{MLA}, focal length of the MLA. FIG. 3(j) shows ray tracing of the light with respect to the experimental prototype.

Organoid preparation. A frozen vial of human iPSC-derived colon organoids (hCOs) was purchased from Millipore Sigma (SCC 300). Organoids were cultured according to the supplier's protocols in general. Briefly, organoid fragments were embedded in 25-μL growth factor reduced Matrigel (GFR MG, Corning 356231) domes (protein concentration 8 mg/mL). After the gels solidified in the incubator, 500-750 μL of media were added. For the first 3 days after thawing or passaging, ROCK inhibitor Y-27632(R&D Systems 1254) were added to the media to prevent cell death. Then media were exchanged every 2 days until the following passage. Organoid culture media components and concentrations are detailed as described in Table 1 below. Organoids used in this work are, in general, at day 5-7 after passaging⁵¹.

TABLE 1

| Component | Supplier Catalog # | Concentration | |
|---|---|---|---|
| B27 supplement | Thermo Fisher 12587010 | 1× | |
| N2 supplement | Thermo Fisher 17502048 | 1× | |
| GlutaMAX | Thermo Fisher 35050061 | 1× | |
| HEPES | Thermo Fisher 15630080 | 15 | mM |
| Human recombinant | R&D Systems 236-EG | 100 | ng/ml |
| epidermal growth factor | | | |
| (EGF) | | | |
| CHIR99021 | R&D Systems 4423 | 3 | μM |
| LDN193189 | Axon Medchem 1509 | 300 | nM |
| A83-01 | R&D Systems 2939 | 500 | nM |
| SB202190 | R&D Systems 1264 | 10 | uM |
| N-Acetyl-L-Cysteine | Sigma A9165 | 1 | mM |
| Nicotinamide | Sigma N0636 | 10 | mM |
| Advanced DMEM/F12 | Thermo Fisher 12634010 | | |

Organoid staining. Matrigel domes containing the organoids were collected using wide-bore P1000 pipet tips. When separating organoids from the gel, scalpels were used, and extra care was taken to maintain the structural integrity of the organoids. After the excessive gel was removed, organoids were suspended in wash media (Advanced DMEM/F12 with 15 mM HEPES and GlutaMAX) containing 5 μM of Syto 16(Thermo Fisher S7578) for nuclei staining. After 30-120 min incubation at 37° C. and 5% CO², wash media was carefully removed without disturbing the organoids. Organoids were gently resuspended in GFR MG containing 5μM of Syto 16, and 10-20 μL of GFR MG containing 1-2 organoids were plated on the imaging chamber. After a brief incubation, the gel construct was covered with wash media with Syto 16 and placed on the microscope stage for imaging.

Application of osmotic stress. 18% (5 mol/L) NaCl solution was made by adding 29.2 g NaCl into 10 ml distilled water in a 15 mL centrifuge tube and mixed using a vortex mixture. The solution was then warmed to 37° C. in a water bath. In the experiment, the isotonic culture medium in the culture dish containing the organoid was replaced by 4 mL pre-warmed PBS. Hyperosmotic stress was applied by adding 1 mL pre-warmed NaCl solution into the PBS gently along the wall of the Petri dish.

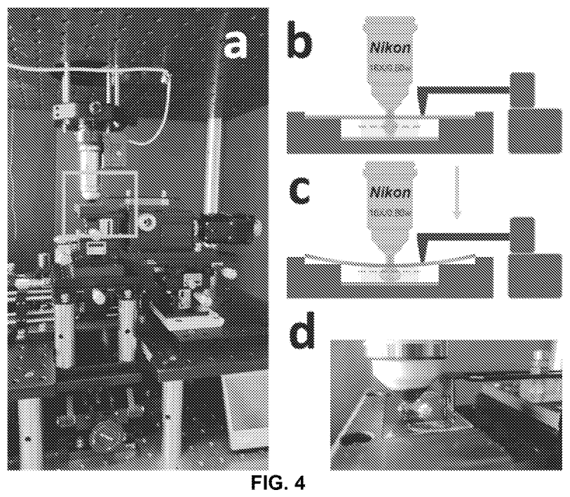

Application of mechanical force. The device to which external force was performed on the hCOs is shown in FIG. 4. The organoids were placed encapsulated in Matrigel on a 22-mm square glass coverslip, laid the slip onto a 3D printed holder placed on the sample stage, and covered by a 60 mm×22 mm glass cover slip. To apply mechanical force on the hCOs in a standard loading-unloading process, the metal plate was moved via a 3D printed mount on a 3D translation stage driven by a stepper motor (MAX383, Thorlabs), which can be controlled and programmed using a computer. In the experiment, the motor was set with a maximum moving distance 300 μm and a dwelling time 30 s. The speed of the moving is set to be 200 μm/s.

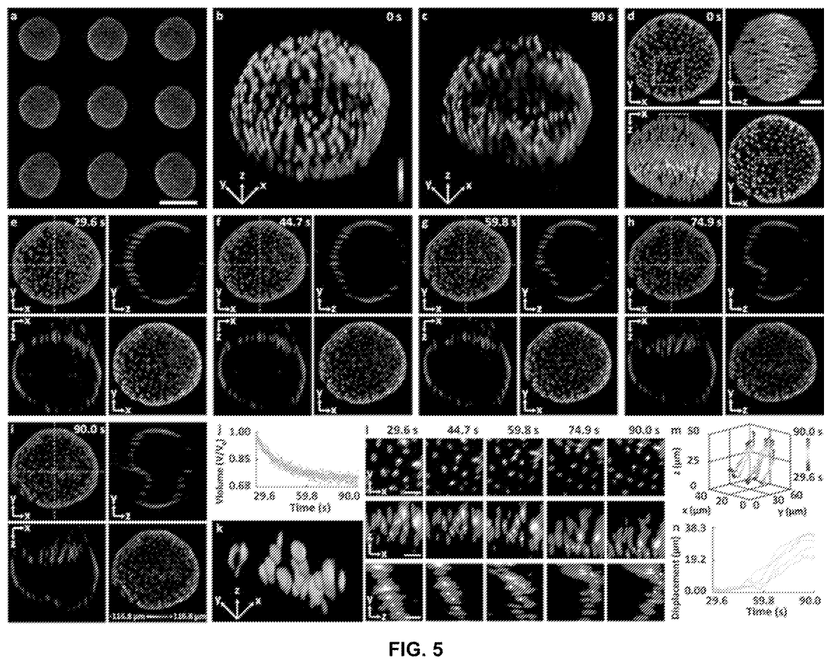

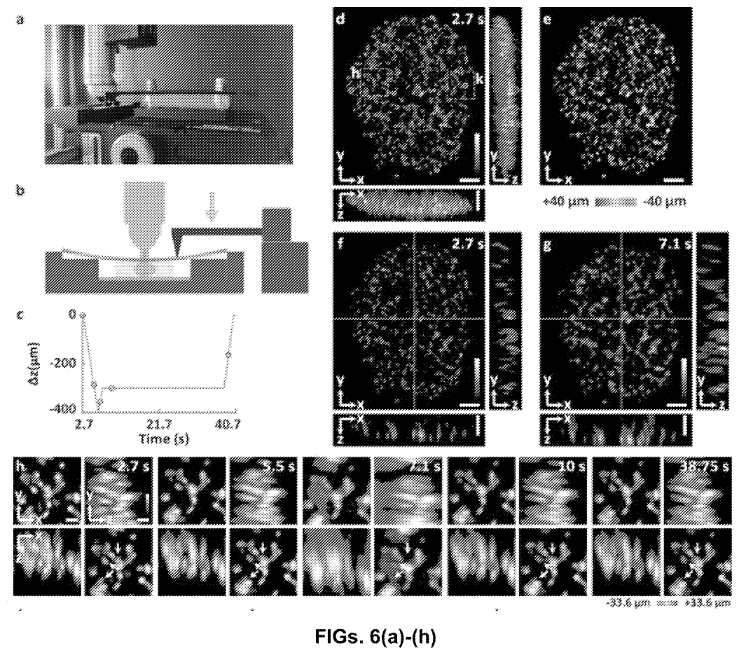

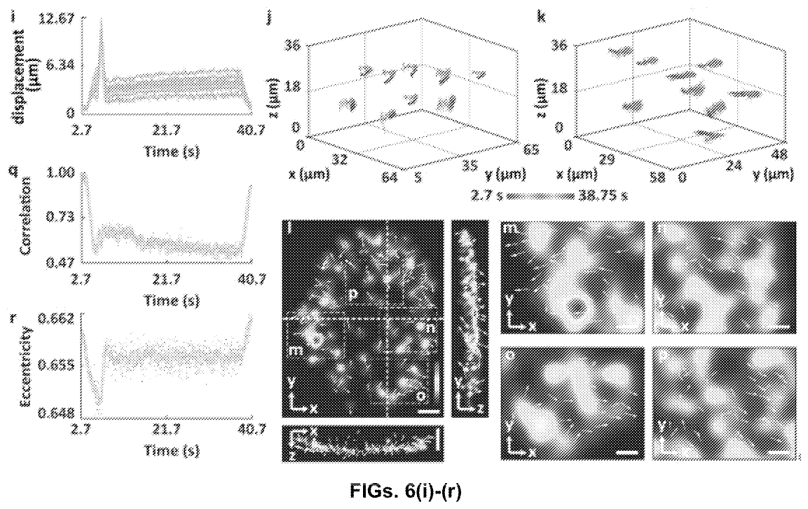

Data analysis. All data processing programs were coded using MATLAB of version 2018a to version 2020b. The hPSF was generated and processed for reconstruction as described above according to, e.g., equations (S1)-(S23). The volume change under osmotic stress in FIG. 5 was measured by processing the volumetric images by the MATLAB function ‘graythreth’, and the volume was calculated as the sum of all non-zeros in the returned binary 3D matrix. For cell positional measurements and tracking in FIGS. 5 and 6, the cell coordinates were determined by localizing the centroid of each cell frame-by-frame.

FIG. 5. Observation of organoids under osmotic stress using hPSF-FLFM. FIG. 5(a) is a raw light-field image, and FIG. 5(b) is a 3D reconstructed hPSF-FLFM. FIG. 5(b) images of a hCO (>200 μm×200 μm×200 μm) stained in the nucleus with Syto 16 and taken at 1=0 s with a volume acquisition time of 10 ms. FIG. 5(c) is the same hPSF-FLFM organoid image taken at t=90 s, revealing structural contraction due to osmotic stress. FIGS. 5(d)-(i) shows Time-lapse hPSF-FLFM images of the organoid at t=0, 29.6, 44.7, 59.8, 74.9, 90.0 s, respectively, displaying x-y MIP, y-z and x-z cross-sectional, depth-coded x-y MIP views of the organoid deformation. The depth information is coded as in the color-scale bar in FIG. 5(i). FIG. 5(j) shows volume variation over >1-min period after osmotic stress was induced during t=1-5 s. FIG. 5(k) is a volumetric rendering of the boxed region in FIG. 5(d). FIG. 5(l) shows x-y, y-z, and x-z views of the volume at time points t=0, 29.6, 44.7, 59.8, 74.9, 90.0 s. FIG. 5(m) shows the 3D trajectories of five cells marked by the white squares in FIG. 5(l). FIG. 5(n) shows corresponding displacements of the five cells over the time period between 29.6 and 90 s, exhibiting an accelerated contraction in this region due to heterogeneous osmotic response. Scale bars are 200 μm for FIG. 5(a), 50 μm for FIGS. 5(d), and 20 μm for FIG. 5(l).

FIG. 6 shows observations of organoids under mechanical perturbation using hPSF-FLFM. FIG. 6(a) is a photo, and FIG. 6(b) is a schematic of the motor-controlled mechanical loading module. FIG. 6(c) is a diagram for mechanical loading and uploading distance by the motor. FIG. 6(d) 3D reconstructed hPSF-FLFM, and FIG. 6(e) is MIP images of a hCO at t=2.7 s. FIGS. 6(f) and (g) show synthesized hPSF-FLFM x-y focal image at z=14.8 μm and corresponding x-z and y-z cross-sectional views along the lines at 1=2.7 s (FIGS. 6(f)) and 7.1 s (FIG. 6(g)), exhibiting organoid deformation due to mechanical stress. FIG. 6(h) shows zoomed-in x-y, x-z, y-z, and depth-coded views of the boxed region in FIG. 6(d) at 1=2.7, 5.5, 7.1, 10.0, 38.75 s as circled in FIG. 6(c), showing the compression and recovery process of single cells (arrows).

The morphological correlation in FIG. 6 was calculated using MIP images and the MATLAB function ‘corr2’ based on the formula:

$$r = \frac{ΣΣ ) ( {A}_{ij} - \overline{A} ) ( {B}_{ij} - \overline{B} )}{\sqrt{( {ΣΣ ( {A}_{ij} - \overline{A} )}^{2} ) ( {ΣΣ ( {B}_{ij} - \overline{B} )}^{2} )}} .$$

The eccentricity of the organoid in FIG. 6 was calculated using formula \sqrt{1−b²/a²}, where a and b represent the major and minor axes and were determined by the farthest cell distances on each axis. The velocity field in FIG. 6 was generated by projecting the frame-to-frame speed of all the cells, which were convolved with a Gaussian low-pass filter of standard deviations at 20 and 10 pixels for lateral and axial dimensions, respectively, for better visualization.

FIGS. 6(i)-(r) show observation of organoids under mechanical perturbation using hPSF-FLFM. FIG. 6(i) show Displacements of representative cells in FIG. 6(h) over time, showing collective responses to mechanical stress FIG. 6(c). FIGS. 6(j) and (k) show 3D trajectories of cells in the corresponding boxed regions in FIG.6(d), showing opposite motions under mechanical stress. FIG. 6(l) is a heat map of averaged velocity distribution at t=5 s in all three dimensions. FIGS. 6(m)-(p) are zoomed-in images of corresponding boxed regions in (l), showing heterogeneous lateral movements under mechanical stress. FIG. 6(q) shows morphology correlation measured through MIP images with respect to the starting frame. FIG. 6(r) show organoid eccentricity over time measured through circled cells in the MIP images in FIG. 6(d). Scale bars are 50 μm for FIGS. 6 (d), (e), (f), (g), and (l), 12 μm for FIG. 6(h), 20 μm For FIGS. 6(m)-(p).

### Experimental Results And Examples

### Light-Field Microscope Design for Organoid Imaging

The design of the light-field system for organoid imaging was derived based upon the theoretical model and general design protocol for FLFM. In particular, a Fourier light-field system consists of optical components in two main categories: (i) the components for a standard epifluorescence setup, including the objective lens, tube lens, and camera, and (ii) the components that generate light-field acquisition, including the Fourier lens (FL) and microlens array (MLA).

As a result, designing an FLFM system is to identify the parameters for both the epifluorescence and light-field components to meet the desired imaging performance.

We designed our hPSF-FLFM system following the general design protocol to satisfy the need for imaging cellular details in whole organoids. In particular, the hPSF-FLFM system consists of two main parts: a standard epifluorescence microscope and a light-field acquisition module. The epifluorescence setup is constituted by an objective lens of the numerical aperture NA and magnification M, a tube lens of focal length fTL, and the camera pixel size P and the physical size of the sensor Dcam. The light-field module includes a Fourier lens (FL) of focal length fFL and a microlens array of diameter dMLA, the occupancy ratio N (i.e. the ratio between the effective pupil size at the MLA Dpupil and dMLA), the focal length of the microlens fMLA, the pitch of the MLA d1, and the distance from the outmost microlens covered by the illumination beam to the center of the MLA dmax. All these design parameters (NA, M, fTL, P, Dcam, fFL, fMLA, dMLA, d1, dmax) are illustrated and can be derived based on the formulas listed in Supplementary Table 1, given the desired imaging performance parameters, including the lateral and axial resolution Rxy and Rz, pixel sampling rate Sr (i.e., the ratio between Rxy and the effective pixel size P/MT, where MT is the total magnification of the hPSF-FLFM system), the field of view FOV, and the depth of field DOF.

Determination of the epifluorescence parameters. We first consider the hPSF-FLFM system to offer cellular resolution (2 to 10 μm) across the whole organoid (hundreds of micrometers to near-millimeter). Correspondingly, the FLFM system is expected to exhibit a single cellular resolution Rxy at a few micrometers, FOV close to 1 mm, and DOF over 200 μm. Based on these needs, we first determined the objective lens of the epifluorescence component, using a water-dipping, low magnification (M=16) and high numerical aperture (NA=0.80) objective lens (Nikon CFI75 LWD 16XW). We used sCMOS cameras with the pixel size (P=6.5 μm) and full sensor size (2048 pixels×2048 pixels, Dcam=13.3 mm). We used a doublet lens as the tube lens (fTL=300 mm). The longer focal length of the tube lens (vs. standard fTLW=200 mm for Nikon objective lenses) allows a longer optical path that benefits the implementation of extra light-field elements. Thus, the resulting magnification of the epifluorescence module is

$${M}_{Epi} = M \frac{{f}_{TL}}{{f}_{TLW}} = 16 \times \frac{300 mm}{200 mm} = 24 \qquad ( S1 )$$

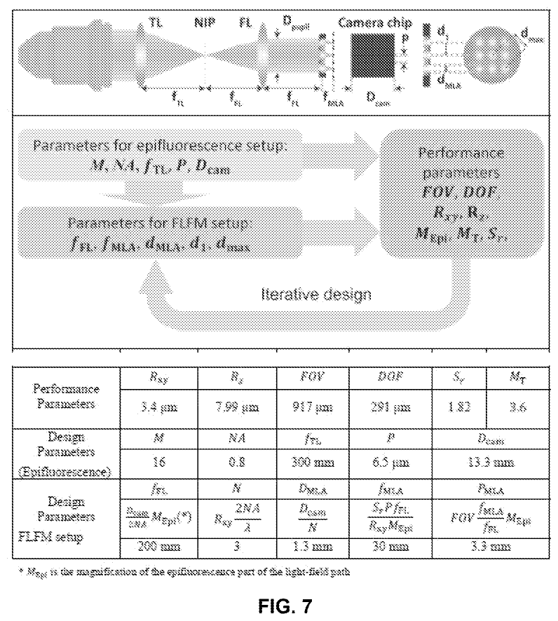

The epifluorescence components were determined, including a water-dipping physiology objective lens (NA=0.80, M=16), a tube lens (f_{TL}=300 mm), and a sCMOS camera (P=6.5 μm, D_{cam}=13.3 mm), where respectively, NA and M represent the numerical aperture and magnification of the objective, f_{TL} represents the focal length of the tube lens, and P and D_{cam} represent the camera pixel size and the physical size of the sensor. Then, the light-field components were determined for organoid acquisition. Specifically, it is contemplated that the tissue imaging performance to exhibit sufficient cellular details in all three dimensions and encompasses whole-mount organoids without tile acquisition. In this sense, the performance parameters as in a 3D cellular resolution (2-3 μm and 5-6 μm in the lateral x and y and axial z dimensions, respectively) and an imaging volume (>900 μm×900 μm×200 μm in x, y, z, respectively). Next, the theoretical model generated a variety of combinatorial performance parameters that meet the expectation, as illustrated in FIG. 7.

One such set of performance parameters was selected as R_{xy}=3.37 μm, R_{z}=7.99 82 m, FOV=917 μm, and DOF=299 μm. Lastly, the design parameters for the light-field components can be obtained as f_{FL}=200 mm, d_{MLA}=1.30 mm, N=3, f_{MLA}=30 mm, d₁=3.30 mm, and dₘₐₓ=4.67 mm. Notably, the high scalability and design flexibility of light-field systems allow this design protocol to produce any possible combination of elements to address different imaging needs in organoid model systems.

For the Fourier light-field module, we first determined the focal length of the Fourier lens, f_{FL}=, based on the equation listed in FIG. 7.

$${f}_{FL} = \frac{{D}_{cam}}{2 NA} {M}_{Epi} = \frac{13.3 mm}{1.6} \times 24 \approx 200 mm \qquad ( S2 )$$

The aperture size d_{MLA} was determined of each lenslet of the microlens array (MLA) to achieve the desired 3D resolution R_{xy} and R_{z}, FOV, and DOF. As reported, this requires an iterative process to satisfy all the derivations and can result in different combinatorial groups of design parameters₁. Here, we finalize the lateral resolution R_{xy}=3.37 μm after iterative design. So, the occupancy ratio is:

$$N = {R}_{xy} \frac{2 NA}{λ} = \frac{3.4 μm \times 2 \times 0.8}{525 nm} \approx 10.4 \qquad ( S3 )$$

This corresponds to aperture size:

$${d}_{MLA} = \frac{{D}_{cam}}{N} = \frac{13.3 mm}{10.4} \approx 1.3 mm \qquad ( S4 )$$

Thirdly, we determined the focal length of the MLA based on the sampling rate Sᵣ of the Fourier light-field system. Typically, the Sᵣ remains the same as the sampling rate of the objective lens. However, the objective lens offers a sampling rate equal to S_{WFM}=0.81 (see equation S14 below), less than the Nyquist sampling rate of 2. Therefore, we expected Sᵣ to double the sampling rate of the objective lens for proper reconstruction. In this sense, Sᵣ=2S_{WFM}=1.82, and as a result, f_{MLA} was determined as:

$${f}_{MLA} = \frac{{S}_{r} {Pf}_{FL}}{{R}_{xy} {M}_{Epi}} = \frac{1.82 \times 6.5 μm}{3.4 μm} \frac{200 mm}{24} \approx 30 mm \qquad ( S5 )$$

This generates a total magnification of the light-field module:

$${M}_{T} = {E}_{Epi} \frac{{f}_{MLA}}{{f}_{FL}} = 24 \times \frac{30 mm}{200 mm} = 3.6 \qquad ( S6 )$$

The effective pixel size Peff is thereby:

$${P}_{eff} = \frac{P}{{M}_{T}} = \frac{6.5 μm}{24} \approx 1.81 μm \qquad ( S7 )$$

Furthermore, the corresponding DOF is:

$$DOF = n \frac{{R}_{xy}^{2}}{λ} ( 2 + \frac{{P}_{eff}}{{R}_{xy}} ) \approx 291 μm \qquad ( S8 )$$

And then the pitch d₁ was determined of the MLA. Increasing the pitch of the MLA creates a larger separation between the elemental images and hence facilitates a larger FOV. To achieve a FOV comparable or larger than the corresponding wide-field imaging (FOV_{WFM}=832 μm, see equation S15 below), the pitch can be determined as:

$${d}_{1} = {FOV}_{WFM} \frac{{f}_{ML}}{{f}_{FL}} {M}_{Epi} = 832 μm \frac{30 mm}{200 mm} \times 24 \approx 3 mm \qquad ( S9 )$$

In practice, we further adapted a 3.3-mm pitch to achieve an increased light-field FOV:

$$FOV = \frac{{P}_{MLA}}{{M}_{Epi}} \frac{{f}_{FL}}{{f}_{ML}} = \frac{3.3 mm}{24} 200 mm30 mm \approx 917 μm \qquad ( S10 )$$

Finally, the pattern of the MLA was determined based on the consideration that both the filling factor of the MLA and dₘₐₓ should be maximized to ensure optimum photon efficiency and axial resolution. Two commonly used MLA patterns are orthogonal and hexagonal. Here, we adopted the orthogonal grid (3×3) with a proper filling factor of approximately 0.55 and dₘₐₓ=4.76 mm. The resulting axial resolution is:

$${R}_{z} = \frac{λ {d}_{1}}{{d}_{max}} {( \frac{1}{{M}_{Epi}} \frac{{f}_{FL}}{{d}_{MLA}} )}^{2} \approx 7.99 μm \qquad ( S11 )$$

A wide-field path (as opposed to the abovementioned epifluorescence module of the light-field path) was constructed for comparison with the light-field results. In this wide-field path, a tube lens (TTL200-A, Thorlabs) of focal length (f_{TLW}=200 mm) was used, which accompanies the Nikon objective lens to obtain the 16× magnification. This path achieves the manufacturer's wide-field performance. For fluorescent emission peaked at 525 nm, it offers the lateral resolution R_{WFM}, lateral sampling pixel size P_{WFM}, sampling rate S_{WFM}, and FOV_{WFM}, respectively, as below:

$$\begin{matrix}{R}_{WFM} = \frac{λ}{2 NA} = \frac{525 nm}{2 \times 0.8} \approx 329 nm & ( S12 ) \\ {P}_{WFM} = \frac{P}{M} = \frac{6.5 μm}{16} = 406.25 nm & ( S 13 ) \\ {S}_{WFM} = \frac{{R}_{WFM}}{{P}_{WFM}} = 0.81 & ( S 14 ) \\ {FOV}_{WFM} = \frac{{D}_{cam}}{M} = \frac{13.3 mm}{16} = 832 μm & ( S 15 )\end{matrix}$$

Another example Fourier Light-Field Microscopy is provided Liu, Wenhao, et al. “Fourier light-field imaging of human organoids with a hybrid point-spread function.” Biosensors and Bioelectronics 208(2022): 114201., which is incorporated by reference herein in its entirety.

### Experimental Setup

On the basis of the design parameters, the imaging system was constructed as an entirely custom-built upright microscope implemented with a 16×, 0.8 NA, water-dipping physiological objective lens and a blue light-emitting diode (LED. As detailed in Methods and Materials, the epifluorescence emission was collected through the customized aperture and dichroic mirror and distributed equally into a wide-field and a light-field path by a 50:50 beam splitter. In the wide-field path, the native image plane (NIP) was recorded using an sCMOS camera as the ground truth and for comparison. In the light-field path, the epifluorescence NIP was Fourier transformed in conjugation to the aperture plane of the objective lens using a Fourier lens. The back focal plane of the Fourier lens was partitioned by a 3×3 customized microlens array (MLA), forming an array of elemental images on its back focal plane, which was recorded by a second sCMOS camera.

Image Formation and Hybrid Point-Spread Functions (hPSF's)

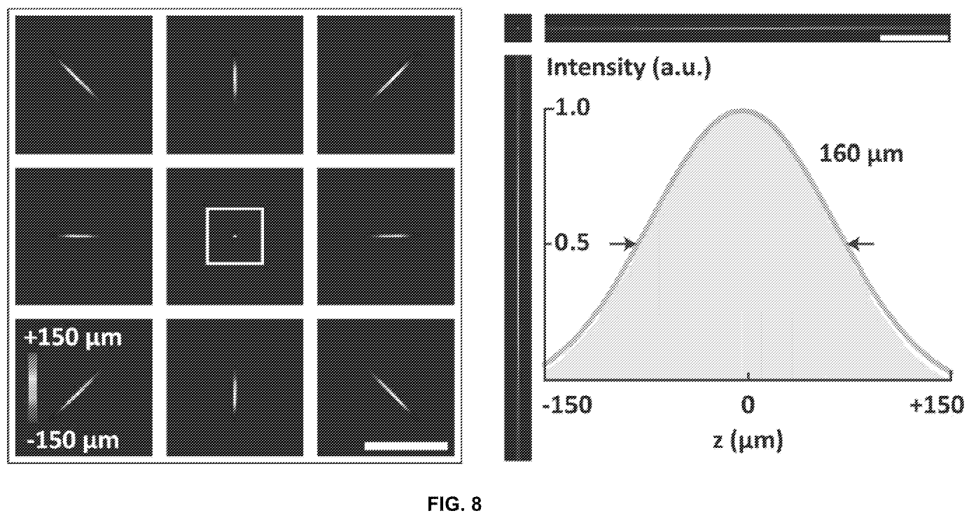

Fourier light-field systems realize spatially uniform sampling and parallel image formation and retrieval, which permits a unified 3D PSF in describing the light-field propagation (FIG. 8). Therefore, the elemental images formed on the camera plane in the light-field path can be considered as the convolution of the object and the 3D PSF, which, an inverse process, underlies the reconstruction of the object space through the deconvolution of the camera image with the 3D PSF. As a result, a 3D PSF to faithfully depict the system determines the reconstruction precision and final image quality, which is especially essential for tissue imaging that utilizes custom elements and collects signals through a considerable volume depth. FIGS. 8(a) and 8(b) show an axial profile of the central hPSF element. FIG. 8(a) is the same as FIG. 2(b) FIG. 8(b) is a cross-sectional profile of the central hPSF element, exhibiting an FWHM value of 160 μm, which corresponds to a 320-μm depth of focus (DOF) by the theoretical definition of the DOF in FLFM1. Scale bars: 100 μm.

In practice, the 3D PSF can be generated through either experimental or numerical procedures. However, for the experimental PSF, the image quality may be affected due to fluorescence fluctuations and a lowering SNR as the imaging depth increases. In contrast, for the numerical PSF, the reconstruction precision may be worsened due to the actual system misalignment or aberrations. Therefore, both strategies may result in a suboptimal reconstruction performance, which becomes especially detrimental for the proposed system to extract fine cellular details throughout a large imaging volume.

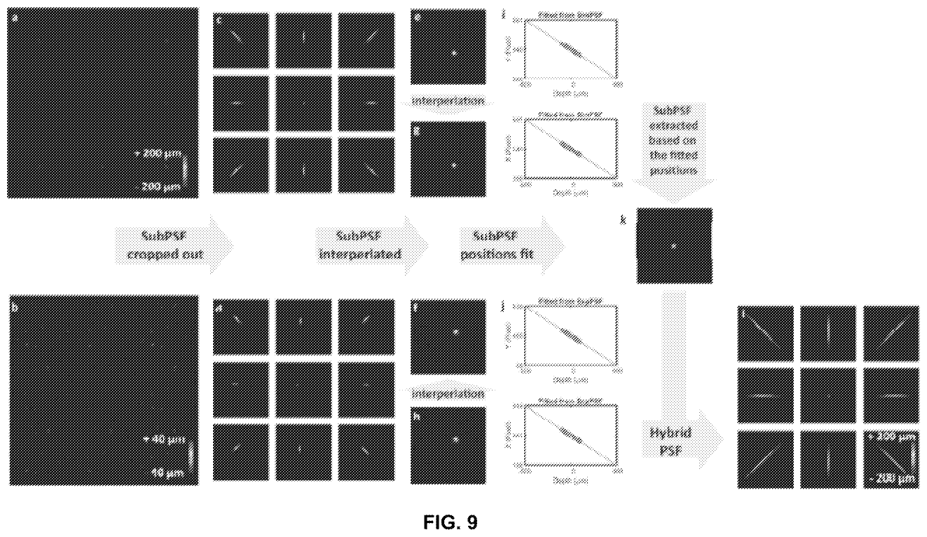

In this disclosure, an hPSF strategy was employed for image analysis (detailed in FIG. 9). FIGS. 9(a)-(f) illustrates the generation of a hybrid point-spread function (hPSF). FIG. 9(a) shows numerically simulated PSF. FIG. 9(b) shows experimentally measured PSF. FIGS. 9(c) and (d) are zoomed-in images of the PSFs cropped from a and b, respectively. FIGS. 9(e)-(h) are PSF images on each layer that were interpolated. FIGS. 9(i)-(k) show corresponding lateral shifts of the corresponding numerical and experimental PSFs were compared and merged. FIG. 9(l) shows the final hybrid PSF using numerical profiles and experimental positions.

In brief, the intensity profiles of the PSF were presented by the numerical PSF, while their spatial locations at each axial position were determined by the experimental results. Here, unlike the previous hPSF solution that only considered the positional deviation at the focal plane, owing to the custom MLA, the PSF may exhibit inconsistent deviations at varying depths, which requires an hPSF to be derived on each layer. Both the experimental and numerical PSFs were generated under the same condition (e.g., the coverslip, water immersion, etc.). Using this hPSF strategy, the reconstruction process was calibrated for deviations while achieving a consistently high SNR to avoid computational artifacts across the entire imaging depth.

### System Characterization Using Caliber and Fixed Cell Samples

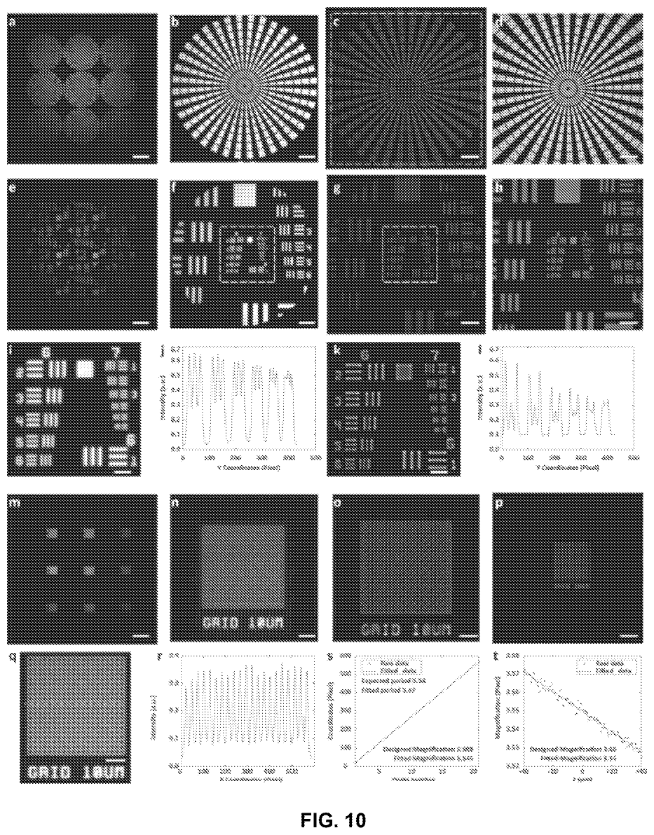

To characterize the performance of the hPSF-FLFM system, caliber samples were first imaged and then the 3D reconstructed images were measured (FIG. 2(c) and FIG. 10), including sector stars (FIG. 2(c)), a negative USAF target, and mesh grid.

FIGS. 10(a)-(t) System characterization using optical targets. from FIGS. 10(a), (e), (m) are raw light-field fluorescent images of a sector star, a USAF 1951 pattern, and a 10-μm mesh grid, respectively. FIGS. 10(b), (f), (n) are central elemental images cropped out from FIGS. 10(a), (e), (m), respectively. FIGS. 10(c), (g), and (o) are synthesized focal images of the reconstructed volumes of from FIGS. 10(a), (e), (m), respectively. FIGS. 10(d), (h), (p) show corresponding wide-field images with respect to FIGS. 10(a), (e), (m). FIGS. 10(i) and (k) are zoomed-in images of the boxed regions respectively in FIGS. 10(f) and (g). FIGS. 10(j) and (l) are cross-sectional intensity profiles along the dashed lines crossing all elements in Group 7 of a USAF 1951 target, respectively, in f and g, resolving structures as close as 2.2 μm. FIG. 10(q) is a zoomed-in image of the 10-μm mesh grid from FIGS. 10(p). FIG. 10(r) is a cross-sectional intensity profile along the dashed line in FIG. 10(q). FIG. 10(s) is a linear fitted line of the coordinates of the peaks of FIG. 10(r) in unit of pixels. The fitted slope exhibits a grid period of 5.47 pixels, indicating the effective pixel size Peff=1.83 μm and total magnification M_{T}=3.54, in good agreement with the theoretical magnification of our designed system is 3.6. FIG. 10(t) shows the linear fitting of the magnification on different layers as in s over a depth range of ±40 μm at a step size of 1 μm, showing a consistent magnification of the exemplary system at different depths. Scale bars: 400 μm (FIGS. 10(a), (b), e), f), m)), 100 μm (FIGS. 10 (c), (d), (g), (h), (p)), 40 μm (FIGS. 10(i), (k), (n, (o), (q)).

The samples were attached to green fluorescent tapes and immersed in water. The reconstructed images were used to determine the FOV (˜900 μm×900 μm), homogeneous magnification (˜3.6×), and lateral resolution (˜2.20 μm) of the system, consistent with our designated performance parameters.

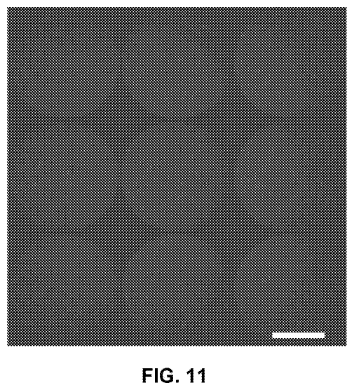

Next, 2-μm green fluorescent beads were imaged while distributed in agarose gel, and the 3D reconstructed images were measured at varying depths (FIG. 2(d) and FIG. 11). FIG. 11 shows a raw Fourier light-field image of the volumetric beads shown in FIG. 2(d). Scale bars: 400 μm.

The focal images of the volume were synthesized by the light-field system taken within a single camera frame, consistent with the 232 axial stacks (step size=400 nm) taken by scanning wide-field microscopy (FIG. 2(e)). The reconstructed images were Gaussian-fitted and exhibited FWHM values of ˜2 μm and ˜6 μm in the lateral and axial dimensions, respectively, across the sample thickness of ˜100 μm (FIGS. 2(f) and (g)), consistent with the theoretical prediction.

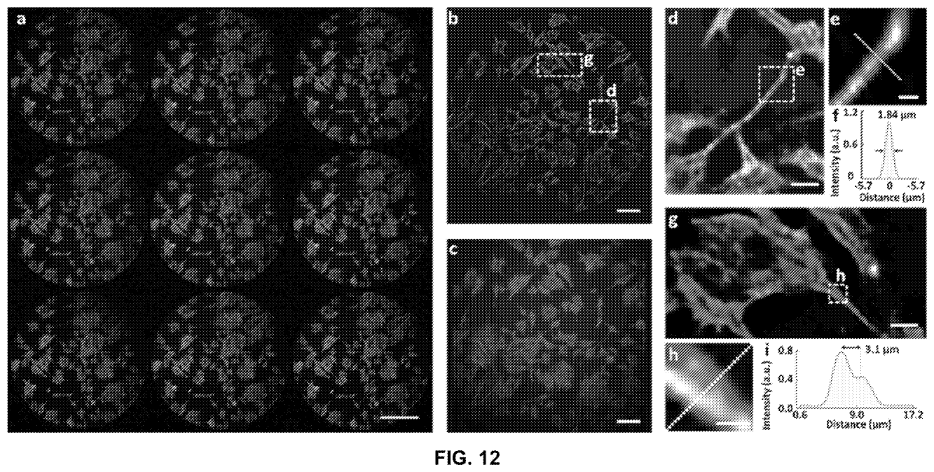

FIG. 12 shows imaging of bovine pulmonary artery endothelial (BPAE) cells using hPSFFLFM. FIG. 12(a) shows raw light-field imaging, and FIG. 12(b) show a 3D reconstructed hPSF-FLFM image of immunostained F-actin in BPAE cells taken at an exposure time of 0.1 s. FIG. 12(c) is a wide-field image of the same area as shown in FIG. 12(b), showing consistent cellular information at a 6% reduced field of view compared to FIG. 12(b). FIGS. 12(d) and (g) are zoomed-in images of the corresponding boxed regions in b. FIGS. 12(e) and (h) are zoomed-in images of the corresponding boxed regions FIGS. 12(d) and (g). FIGS. 12(f) and (i) are cross-sectional intensity profiles along the corresponding dashed lines in FIGS. 12(e) and (h), respectively, showing well-resolved subcellular filamentary structures. Scale bars are 250 μm (FIG. 12(a)), 100 μm (FIGS. 12(b), (c)), 20 μm (FIGS. 12(d) and (g)), five μm (FIGS. 12(e) and (h)).

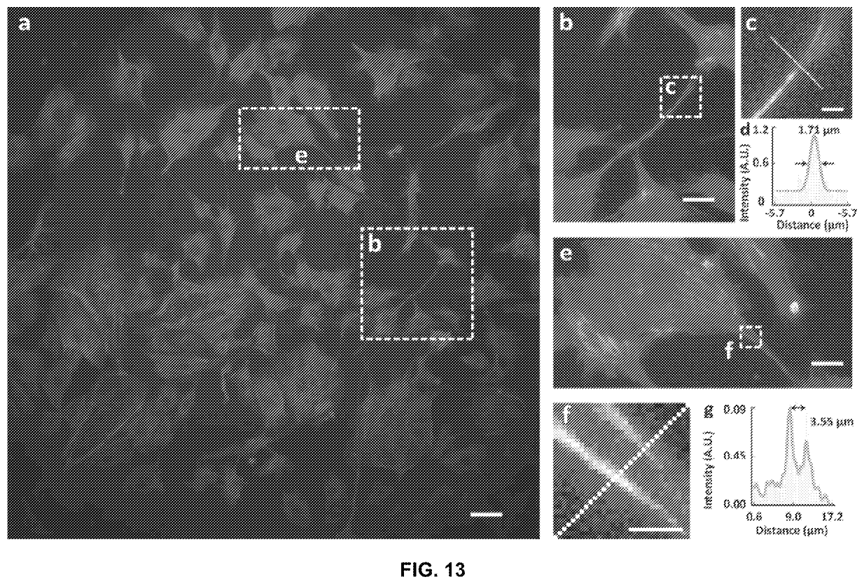

Lastly, to demonstrate cell imaging, the F-actins of bovine pulmonary artery endothelial (BPAE) cells were recorded on a cover slide with phalloidin immuno-stained by Alexa Fluor 488 (FIG. 12(a)). Notably, the reconstructed light-field image showed consistent subcellular details compared to the same region taken by the wide-field path while providing a ˜6% increase in the FOV (FIG. 12(b) and (c)). The delicate structural variations of actin bundles can be detectable in the synthesized focal stack, showing consistent morphology with the wide-field image (FIG. 12(d)-(i) and FIG. 13.

FIG. 13 shows wide-field images of the bovine pulmonary artery endothelial (BPAE) cells as shown in FIG. 12. Scale bars: 50 μm (FIGS. 12(b), (c)), 20 μm (FIGS. 12(d) and (g)), five μm (FIGS. 12(e) and (h)).

In particular, the cross-sectional profiles exhibited that actin bundles of 2-3 μm were well resolved in the light-field images (FIGS. 12(d)-(i)), presenting a lateral resolution consistent with the measurements using the caliber samples (FIG. 2 and FIG. 10).

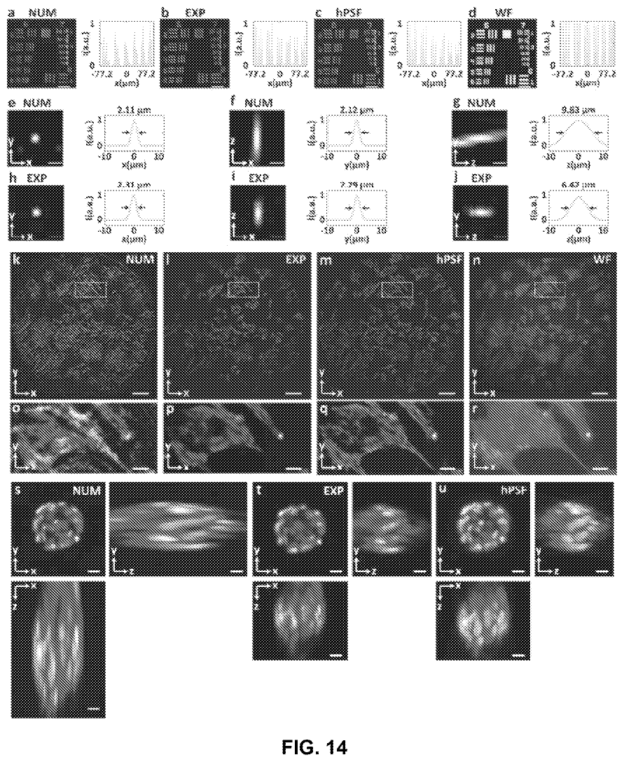

Notably, in the system characterization procedure, it was also validated that for the custom-built system, the hPSFs exhibited a substantial improvement in the reconstruction precision and final image quality of various caliber and biological samples over the corresponding results obtained by experimental or numerical PSFs (FIG. 14).

FIG. 14 shows a comparison of volumetric reconstruction using the numerical, experimental, and hybrid PSFs. The left panels of FIGS. 14(a)-(d) show reconstruction of a USAF 1951 target using numerically simulated PSF (FIG. 14(a)), experimentally recorded PSF (FIG. 14(b)), the hybrid PSF (FIG. 14(c)), and the wide-field image of the target (FIG. 14(d)). Corresponding right panels show cross-sectional intensity profiles along the dashed lines, showing the resolution of 2.2-μm structures in Group 7 of the target using the hPSF. FIGS. 14(e)-(j) show reconstructed x-y, x-z, and y-z images and their corresponding cross-sectional profiles of the 2-μm bead as measured in FIG. 2(f) and (g) using numerical and experimental PSFs, indicating improved reconstruction with the hPSF, especially in the axial dimension. FIGS. 14(k)-(r) show the reconstruction of the BPAE cells as in FIG. 12, indicating potential artifacts and missing information using the numerical or experimental PSFs. FIGS. 14(s)-(u) are 3D reconstructed MIP images of human colon organoids stained with Syto 16 in the nucleus using numerical, experimental, and hybrid PSFs, respectively. Distortions and artifacts are noticeable, especially in the axial dimension, using the numerical and experimental PSFs. Scale bars: 50 μm (FIGS. 14(a)-(d)), 5 μm (FIGS. 14(e)-(j)), 100 μm (FIGS. 14(k)-(n)), 20 μm (FIGS. 14(o)-(r)), 10 μm (FIGS. 14(s)-(u)).

Here, the hPSF approach can effectively tackle practical light propagation due to customized elements such as the MLA and information loss or retrieval defects due to the inadequate SNR, permitting the optimum reconstruction of organoid samples.

### System Characterization Using Organoid Samples

Fourier light-field imaging was demonstrated of 10-days old human iPSC-derived colonic organoids (hCOs), which were contained in Matrigel and incubated with a nucleic acid stain, Syto16 (Methods and Materials).

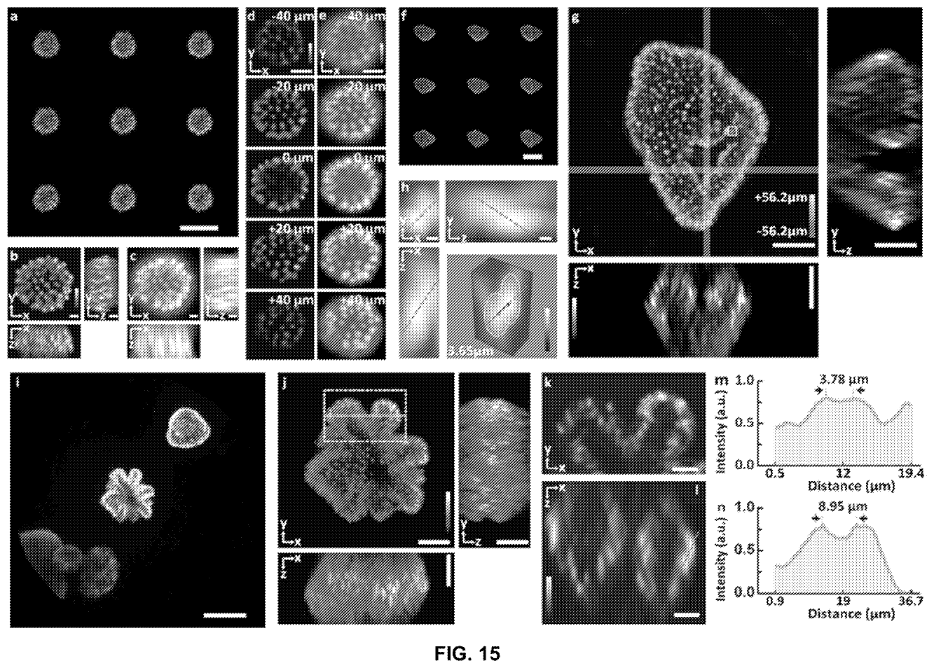

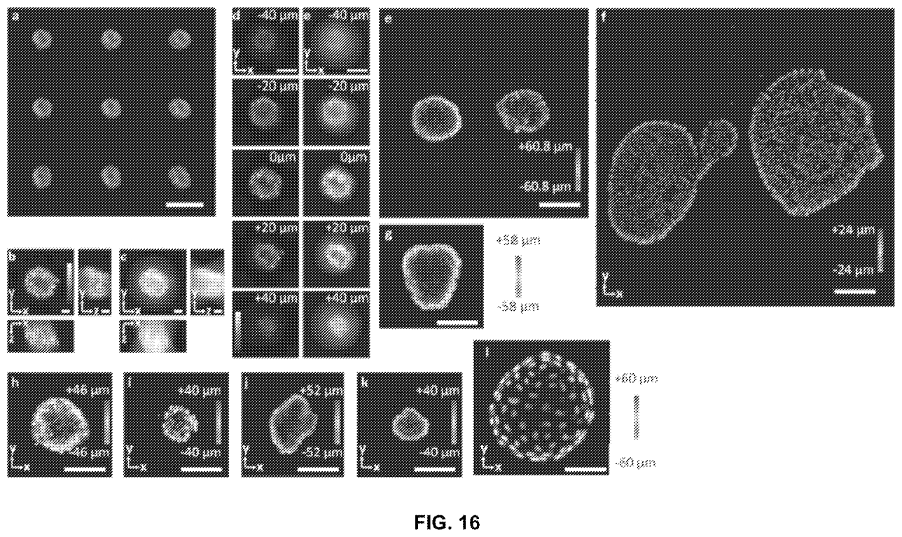

FIG. 15 shows imaging of organoids using hPSI-FLFM. FIG. 15(a) shows a raw light-field image, and FIG. 15(b) shows a 3D reconstructed hPSF-FLFM image of hCOs stained in the nucleus with Syto 16 and taken at an exposure time of 0.1 s. FIG. 15(c) is a scanning wide-field MIP image of the same organoid, acquired by overlaying 202 axial stacks at a step size of 400 nm. FIG. 15 (d) are synthesized light-field images that show consistent cellular structures and enhanced optical sectioning and contrast throughout an 80-μm depth range in comparison with widefield stack images. FIG. 15(f) is a raw light-field image, and FIG. 15(f) is a 3D reconstructed hPSF-FLFM. FIG. 15(g) is an image exhibiting a prominent hollow lumen of hCOs in all three dimensions (insets). FIG. 15 (h) is a set of zoomed-in images of the boxed volume in FIG. 15(g), showing well-resolved 3D individual nucleic structures separated as close as 3.65 μm. FIG. 15(i) is a central element of the raw 3×3 light-field images of multiple hCOs captured in one camera frame. FIG. 15(j) is a 3D reconstructed hPSI-FLFM image of a budded organoid. FIGS. 15 (k) and (l) are zoomed-in images of the boxed crypts (FIG. 15(k), x-y) and along the yellow line (FIG. 15(l), x-z) in FIG. 15(j), displaying a thin epithelial lining separating the lumen from the outer environment. FIGS. 15 (m) and (n) are cross-sectional profiles along the red dashed lines in FIGS. 15 (k) and (l), respectively, resolving epithelial cellular structures at a few micrometers in all three dimensions. Scale bars: 100 μm (FIG. 15(a)), 20 μm (FIGS. 15(b), (c), (k), (l)), 50 μm (FIGS. 15 ( d), (e), (g), (j)), 2 μm (FIG. 15(h)), 200 μm (FIG. 15(f)), 150 μm (FIG. 15(i)). As seen, the organoids can be visualized exhibiting a wide variety of tissue morphology at this developmental stage (FIG. 15 (a), (f), (i), and FIG. 16). FIG. 16 shows additional results on the light-field and 3D reconstructed images of human colon organoids. Scale bars: 100 μm (FIGS. 16(a), (e)-(k)), 20 μm (FIGS. 16(b), (c)), 50 μm (FIGS. 16(d), (e), (l)).

The system recorded the incident light field of each organoid into nine elemental images, allowing for the reconstruction of the full volume of organoid samples using a single camera frame at a volume acquisition time of 0.1 s. Remarkably, hPSI-FLFM is able to recover the nucleic structures in organoids that were out-of-focus and poorly sectioned with axial stacks using wide-field microscopy (FIG. 15(b)-(e) and FIG. 16). For example, the system clearly resolved the hollow lumen of the organoid in all three dimensions, a prominent feature of hCOs (FIG. 15(g)). Also, the 3D reconstructed image of two adjacent crypts of a budded organoid displayed the entire thin epithelial lining separating the lumen from the outer environment (FIGS. 15(j)-(l)). Quantitatively, the high 3D resolution allows us to characterize the organization of individual cellular nuclei in organoids that are separated as close as ˜3 μm in all three dimensions (FIGS. 15(h), (m), (n)). Also, the large imaging volume of the light-field system allows the capturing of the complete and multiple organoids that can span a diameter over hundreds of micrometers without the need for scanning or tile acquisition. Here a large batch of organoids was able to be screened at a fast snapshot rate (primarily determined by the camera speed), which procedure may require minutes to hours per organoid of a comparable volume using confocal or light-sheet microscopy. This improvement exhibits >2-3 orders of magnitude faster in the volumetric acquisition, promising substantial abilities to capture rapid dynamic processes while maintaining minimum phototoxicity per organoid acquisition, as well as for within-batch variability analysis for high throughput drug screening assay.

Observation of hCOs Under Osmotic Stress

Extracellular physical cues such as the osmotic and mechanical stresses dynamically regulate a number of physiological processes that underlie the growth and homeostasis of organoids in vitro. However, the impact of these extracellular physical cues on organoids remains elusive because, at the microscopic level, the cellular compartments in tissue exhibit remarkable spatiotemporal dynamics and heterogeneity in response to the environmental cues, thus posing a challenge for the instantaneous recording of the processes throughout the organoid volume using conventional imaging methods.

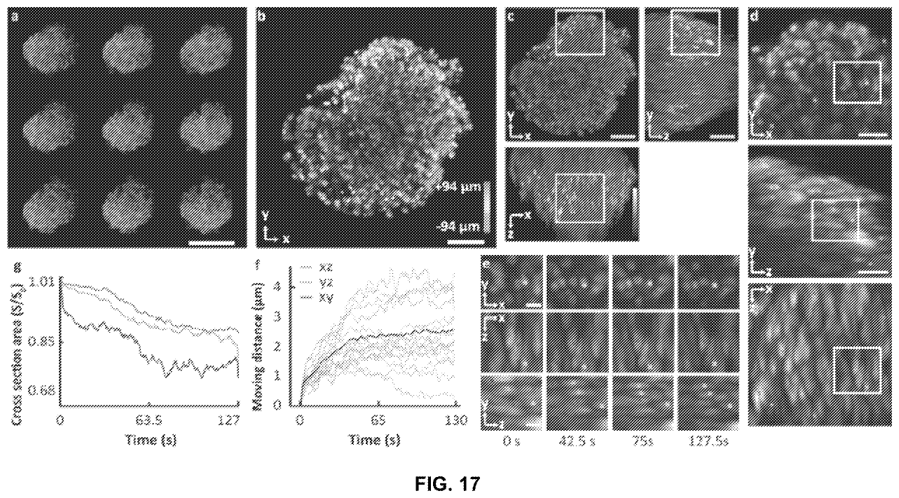

Here, the light-field observation of hCOs was first demonstrated under osmotic stress. For this experiment, 5-7 days old hCOs were embedded in Matrigel, and the nucleus stained with Syto16. Hyperosmotic stress was applied while imaging by adding pre-warmed NaCl solution to the isotonic culture medium (Methods and Materials). Without the need for scanning, hPSF-FLFM conducted a continuous time-lapse observation of organoids with low wide-field light exposure (<0.6 mJ·cm⁻² per volume acquisition) at a volume acquisition time of 10 ms over tens of thousands of time points without noticeable photodamage (FIG. 5(a) and FIG. 17).

FIG. 17 shows additional results on the observation of human colon organoids under osmotic stress over 130 s at the volumetric acquisition time=10 ms. FIG. 17(a) is a raw light-field image of the organoid. FIGS. 17(b) and (c) show 3D reconstructed volume. FIG. 17(d) is a set of zoomed-in 3D MIP images of the boxed volume in FIG. 17(c). FIG. 17(e) is a set of zoomed-in 3D MIP images of the boxed volume in FIG. 17(d). Color squares in FIGS. 17 (d) and (e) mark the cells selected for tracking over time. FIG. 17(f) shows 3D displacements (gray curves) of the cells as marked in FIG. 17(d), the black curve shows the average movement. FIG. 17(g) shows cross-sectional area change in all three dimensions, exhibiting volumetric compression due to osmotic stress. Scale bars: 150 μm (FIG. 17(a)), 50 μm (FIGS. 17(b) and (c)), 20 μm (FIG. 17(d)), 2 μm (FIG. 17(e)).

Notably, the reconstructed images clearly identified >200 micrometer-level individual nuclei over the entire sample volume>200 μm×200 μm×200 μm within a single camera snapshot, revealing that the cellular architecture is organized across a single-cell layer to form the spherical epithelial lining of the organoid (FIGS. 5(b) and (c)). As the NaCl solution was introduced gradually between 1=1-5 s, the entire organoid rapidly reduced under the osmotic pressure as a result of water efflux from the intact organoids. This instant large-scale collective process has been primarily observed only in single cells with conventional imaging methods (FIGS. 5 (d)-(i)). As observed, the whole volume underwent instant compression at the beginning, and subsequently, a subregion at the top of the organoid contracted inwards abruptly, indicating the high spatiotemporal heterogeneity of the cellular response to the osmotic stress (FIGS. 5 (d)-(i)). Over a time period of ˜1.5 min, it is observed that the volume of the hCO was reduced by 32.3% under the hypertonic condition with the 4.52% NaCl solution, compared with that in the original isotonic media (FIGS. 5 (j)). Furthermore, the high resolution of hPSI-FLFM allows us to characterize the dynamic process under osmotic cues at the single-cell level. In particular, the cells in all three dimensions were continuously tracked within the most dynamic subregion close to the top of the organoid (FIGS. 5 (k)-(n)). As seen, the cells exhibited moderate motions at the initial stage as a part of the collective volumetric compression and were substantially accelerated to a local structural contraction due to the osmotic stress (FIG. 5 (n)). These results demonstrated the ability of light-field observation of volumetric organoid dynamics without compromising the spatial and temporal resolution. It should also be noted that with multi-color imaging, the spatiotemporal resolution of hPSF-FLFM will allow us to characterize individual cell volume changes with richer information, promising the study of extracellular cues in a multiscale manner from the intact organoid to the single-cell levels.

Observation of hCOs Under Mechanical Compression

Next, the light-field observation of mechanical compression of hCOs was demonstrated. To apply a mechanical load, organoids were encapsulated in Matrigel patty and top-covered by a cover glass. A motor-controlled cantilever was placed on the cover glass to introduce a vertical compression with sub-micrometer motor accuracy (FIG. 6(a) FIG. 4, and Methods and Materials). The large working distance of the light-field system allows the accessibility of the force manipulation to real-time image acquisition (FIG. 6(a) and (b), FIG. 4).

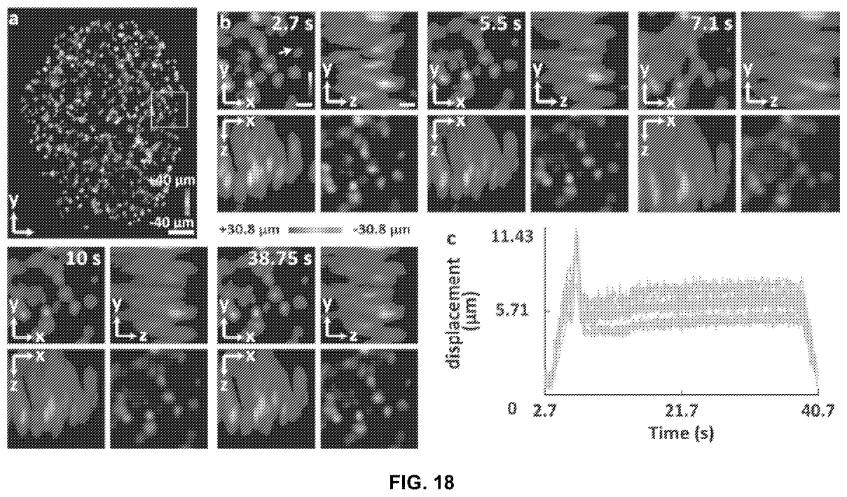

Using this platform, the time-dependent responses of organoids to mechanical forces through a standard loading-unloading experiment (FIG. 6(c)) were measured. During the cycle, the cover glass was first pressed downwards with a constant speed of 200 μm/s until reaching the programmed maximum displacement of 300 μm, where notably, the movement exhibited an intrinsic 100-μm overrun due to the inertial movement of the motor. The cover glass then remained stationary for 30 s to equilibrate to the pressure within the organoid before it was released upwards at the same speed back to its original position. While the thickness of the gel was kept at a minimum to affix the organoids and to reduce its influence on the mechanical deformation of the tissue, it should be mentioned that the embedding gel was also deformed in the same direction under vertical compression by the cover glass, causing an overall displacement of the organoid, which was excluded from the actual tissue deformation in the analysis to display the nuclei displacement solely due to the compression (Methods and Materials). The collective behavior was recorded continuously at a volume acquisition time of 10 ms over the entire course of mechanical perturbation and reconstructed using the hPSF (FIGS. 6(d)-(g)). As seen, the entire organoid sample first deformed quickly upon application of mechanical stress, then achieved an equilibrate deformed state as the compression was kept constant, and elastically recovered close to its original morphology as the stress was relieved. Remarkably, even though both the loading and unloading stages were completed within only 1-2 seconds, and the high spatiotemporal resolution and volumetric ability of the system allowed capture of the entire dynamic processes with well-resolved cellular-level spatial and temporal details, which exhibited correlative behavior among adjacent cells under the loading and unloading stress (FIGS. 6(h)-(k) and FIG. 18).

FIG. 18 shows additional results on cells tracking as shown in FIG. 6(k). FIG. 18(a) shows a depth-coded x-y MIP image of the entire reconstructed volume of the whole organoid as in FIG. 6(e). FIG. 18(b) is a zoomed-in image in x-y, x-z, y-z, and depth-coded views of the boxed region in FIG. 18(a) at t=2.7, 5.5, 7.1, 10.0, 38.75 s. FIG. 18(c) shows displacements of the selected cells as in FIG. 6(k) over time, showing consistent movement as other cell groups in FIG. 6(i). Scale bars are 50 μm (FIGS. 18(a)), and 10 μm (FIG. 18(b)).

Over the whole organoid, this ability to extract spatiotemporal characterizations of individual cells leads to the 3D mapping of the velocity variations upon mechanical perturbation, which revealed, at the microscopic level, a global vertical deformation but highly heterogeneous lateral movements, despite the expected observation of lateral expansion in response to the indentation in some subregions (FIGS. 6(l)-(p)). To quantify collective behaviors, the morphological correlation of the whole organoid over the entire test indicated instantaneous and elastic deformation, maintenance of mechanical energy, and recovery upon relaxation (FIG. 6(q)). Furthermore, the quantification of the eccentricity revealed heterogeneous tissue behaviors in the lateral dimension in response to vertical mechanical cues (FIG. 6(r)). Interestingly, enabled by the high resolution, both the cellular displacements and organoid eccentricity showed a slight viscous response during the indentation, implying the potential dissipation of mechanical energy owing to either the internal microenvironment of the tissue or the elasticity of the embedding gel (FIGS. 6(i), (q) and (r)).

### Discussion

Organoids are stem cell-derived 3D multicellular in vitro tissue constructs that recapitulate the pertinent in vivo organs. These miniaturized and simplified model systems have a remarkable resemblance to the microscale tissue architectures and key functionalities of their in vivo counterparts, overcoming the barriers of classical cell line and animal model systems to understanding human biology and medicine. The recent advances of various organoid systems have demonstrated their great potential and promise in modeling tissue development and disease, high scalability and amenability to biomaterials and protocols, and in a wide range of applications in basic biology, drug discovery, and regenerative medicine.

Essentially, thorough exploitation of the promises of organoids requires a detailed picture of the cellular complexity modeled with organoids. Indeed, fluorescence microscopy has become a major driving force to probe this complexity—to reveal the phenotypic and functional states of organoid development and pathogenesis, gaining us critical insights relevant to their original organs. Unlike traditional tissue sectioning, organoids are generated in 3D matrices and thereby necessitate live, noninvasive observation to study fine cellular details within an intact tissue architecture in vitro. To address this need, one major consideration underlying live imaging of organoids lies in the balance between volumetric capability (e.g., the spatiotemporal resolution, signal-to-noise ratio (SNR), optical sectioning) and sample health (e.g., phototoxicity, photobleaching). Conventional wide-field systems, for instance, have difficulty to visualize 3D cultures with more than 2-3 cell layers due to the lack of optical sectioning. Major 3D fluorescence microscopy techniques such as confocal, multiphoton, and light-sheet fluorescence microscopy have thus far substantially transformed the study of complex 3D structures and processes of organoids at the cellular and subcellular levels. All these techniques have contributed to elegant 3D characterizations of fixed and cleared intact organoids. However, though confocal or multiphoton laser scanning techniques offer a high 3D resolution, they are time-consuming and may lead to increased photodamage, making the strategies less optimum for live imaging of large organoid samples. By contrast, light-sheet microscopy provides effective optical sectioning without significant photobleaching and altered physiology of organoid specimens, thus becoming a valuable tool for the long-term investigation of live organoids. However, the light-sheet methods remain suboptimal in broad applicability, primarily due to the inadequate volumetric image throughput. Specifically, the underlying light-sheet scanning mechanism, augmented by potential tile stitching, inevitably entails a compromised volume time resolution, especially when capturing complete or multiple organoids ranging over hundreds of micrometers, leading to an unmet imaging gap for organoid study to capture fast cellular and tissue dynamic processes in a simultaneous, volumetric manner (e.g., collective cellular responses at sub-second time scales across whole organoids).

The development of light-field microscopy (LFM) techniques suggests a promising solution to organoid imaging. In principle, LFM can simultaneously capture both the 2D spatial and 2D angular information of light, permitting computational retrieval of the volume of a biological sample from a single camera frame. Furthermore, the recent advances into Fourier LFM (FLFM, or extended LFM-XLFM) have overcome the intrinsic uneven sampling of the optical signals in LFM, achieving substantially enhanced volume image quality and computational efficiency. The advancement has revolutionized the volumetric study of various biological samples at cellular to subcellular, milliseconds spatiotemporal resolution, ranging from the functional brain to single-cell specimens. Therefore, despite remaining unexplored, the Fourier light-field methodology promises fast snapshot and scanning-free recording of intact organoids and their dynamic cellular processes with minimum photodamage per volumetric acquisition compared to existing techniques.

In practice, however, such a Fourier light-field system demands two major considerations to transform conventional schemes suitable for organoid study. First, organoid model systems present a wide morphological and functional variability and thus require flexible configurations to obtain cellular details at versatile spatiotemporal scales. Here, the detailed design modeling and protocol and corresponding instrumental strategies are provided for constructing the microscope so that the approach can be readily adjustable to a wide range of organoids of various dynamics, sizes, and shapes. Second, existing Fourier light-field tissue imaging methods rely on numerical or experimental point-spread functions (PSFs) to retrieve volumetric information. They have offered adequate reconstruction precision and final image quality of tissues in two main scenarios. Numerical PSFs provide faithful simulation for imaging systems using standard optical elements (e.g., commercial microscope frame, mass-produced microlens arrays) as opposed to custom-built systems and parts, which may exhibit various alignment deviations in practice. In contrast, experimental PSFs have been demonstrated for accurate recording of neural activities that exhibit sufficient spatiotemporal sparsity. At the same time, fluorescence fluctuations and a low SNR in increased depths may cause reconstruction defects to extract more densely packed cellular signals beyond neural spikes. In this regard, the system performance was optimized by developing hybrid point-spread functions (hPSFs) to address the uniformity of the SNR and practical alignment in a customized system, which merge the advantage of both numerical and experimental results, essential for optimum organoid reconstruction.

Achieving these advances, in this work, a custom-built hPSI-FLFM system was introduced for fast, volumetric, and high-resolution imaging of entire organoids. In particular, the 3D visualization demonstrated the impact of extracellular physical cues on human induced pluripotent stem cells-derived colon organoids (hCOs). The system offers cellular, milliseconds spatiotemporal details of whole-organoid dynamic changes spanning hundreds of micrometers in all three dimensions in instantaneous response to extracellular cues such as osmotic stresses and mechanical forces. It is contemplated that the easy adaptability to standard epifluorescence protocols of hPSF-FLFM and its cost-efficient scalability facilitate the approach to the wide variability of organoid model systems. It is contemplated that the light-field method can be used to evaluate spatiotemporal-challenging cellular responses in a broad range of organoid research.

It should be appreciated that the logical operations described above and in the appendix can be implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as state operations, acts, or modules. These operations, acts and/or modules can be implemented in software, in firmware, in special purpose digital logic, in hardware, and any combination thereof. It should also be appreciated that more or fewer operations can be performed than shown in the figures and described herein. These operations can also be performed in a different order than those described herein.

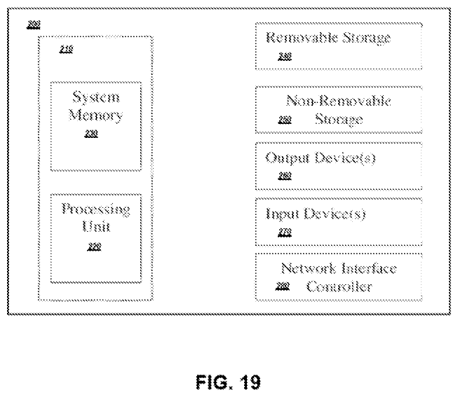

In addition to the system and methods discussed herein, FIG. 19 shows an illustrative computer architecture for a computer system 200 capable of executing the software components that can use the output of the exemplary method described herein. The computer architecture is shown in FIG. 19 illustrates an example computer system configuration, and the computer 200 can be utilized to execute any aspects of the components and/or modules presented herein described as executing on the analysis system or any components in communication therewith.

In an embodiment, the computing device 200 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computing device 200 to provide the functionality of a number of servers that are not directly bound to the number of computers in the computing device 200. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In its most basic configuration, computing device 200 typically includes at least one processing unit 220, and system memory 230. Depending on the exact configuration and type of computing device, system memory 230 may be volatile (such as random-access memory (RAM)), non-volatile (such as read-only memory (ROM), flash memory, etc.), or some combination of the two.

This most basic configuration is illustrated in FIG. 19 by dashed line 210. The processing unit 220 may be a standard programmable processor that performs arithmetic and logic operations necessary for the operation of the computing device 200. While only one processing unit 220 is shown, multiple processors may be present. As used herein, processing unit and processor refers to a physical hardware device that executes encoded instructions for performing functions on inputs and creating outputs, including, for example, but not limited to, microprocessors (MCUs), microcontrollers, graphical processing units (GPUs), and application-specific circuits (ASICs). Thus, while instructions may be discussed as executed by a processor, the instructions may be executed simultaneously, serially, or otherwise executed by one or multiple processors. The computing device 200 may also include a bus or other communication mechanism for communicating information among various components of the computing device 200.

Computing device 200 may have additional features/functionality. For example, computing device 200 may include additional storage such as removable storage 240 and non-removable storage 250 including, but not limited to, magnetic or optical disks or tapes. Computing device 200 may also contain network connection(s) 280 that allow the device to communicate with other devices such as over the communication pathways described herein. The network connection(s) 280 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. Computing device 200 may also have input device(s) 270 such as keyboards, keypads, switches, dials, mice, track balls, touch screens, voice recognizers, card readers, paper tape readers, or other well-known input devices. Output device(s) 260 such as printers, video monitors, liquid crystal displays (LCDs), touch screen displays, displays, speakers, etc. may also be included. The additional devices may be connected to the bus in order to facilitate the communication of data among the components of the computing device 200. All these devices are well-known in the art and need not be discussed at length here.

The processing unit 220 may be configured to execute program code encoded in tangible, computer-readable media. Tangible, computer-readable media refers to any media that is capable of providing data that causes the computing device 200 (i.e., a machine) to operate in a particular fashion. Various computer-readable media may be utilized to provide instructions to the processing unit 220 for execution. Example of tangible, computer-readable media may include, but is not limited to, volatile media, non-volatile media, removable media, and non-removable media implemented in any method or technology for storage of information such as computer-readable instructions, data structures, program modules or other data. System memory 230, removable storage 240, and non-removable storage 250 are all examples of tangible, computer storage media. Examples of tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In light of the above, it should be appreciated that many types of physical transformations take place in the computer architecture 200 in order to store and execute the software components presented herein. It also should be appreciated that the computer architecture 200 may include other types of computing devices, including hand-held computers, embedded computer systems, personal digital assistants, and other types of computing devices known to those skilled in the art. It is also contemplated that the computer architecture 200 may not include all of the components shown in FIG. 19, may include other components that are not explicitly shown in FIG. 19, or may utilize an architecture different than that shown in FIG. 19.

In an example implementation, the processing unit 220 may execute program code stored in the system memory 230. For example, the bus may carry data to the system memory 230, from which the processing unit 220 receives and executes instructions. The data received by the system memory 230 may optionally be stored on the removable storage 240 or the non-removable storage 250 before or after execution by the processing unit 220.

The development of light-field microscopy (LFM) techniques suggests a promising solution to organoid imaging. In principle, LFM can simultaneously capture both the 2D spatial and 2D angular information of light, permitting computational retrieval of the volume of a biological sample from a single camera frame. Furthermore, the recent advances into Fourier LFM (FLFM, or extended LFM-XLFM) have overcome the intrinsic uneven sampling of the optical signals in LFM, achieving substantially enhanced volume image quality and computational efficiency. The advancement has revolutionized the volumetric study of various biological samples at cellular to subcellular, milliseconds spatiotemporal resolution, ranging from the functional brain to single-cell specimens. Therefore, despite remaining unexplored, the Fourier light-field methodology promises fast snapshot and scanning-free recording of intact organoids and their dynamic cellular processes with minimum photodamage per volumetric acquisition compared to existing techniques.

In practice, however, such a Fourier light-field system demands two major considerations to transform conventional schemes suitable for organoid study. First, organoid model systems present a wide morphological and functional variability and thus require flexible configurations to obtain cellular details at versatile spatiotemporal scales. Here, we provide detailed design modeling and protocol and corresponding instrumental strategies for constructing the microscope so that the approach can be readily adjustable to a wide range of organoids of various dynamics, sizes, and shapes. Second, existing Fourier light-field tissue imaging methods rely on numerical or experimental point-spread functions (PSFs) to retrieve volumetric information. They have offered adequate reconstruction precision and final image quality of tissues in two main scenarios. Numerical PSFs provide faithful simulation for imaging systems using standard optical elements (e.g., commercial microscope frame, mass-produced microlens arrays) as opposed to custom-built systems and parts, which may exhibit various alignment deviations in practice. In contrast, experimental PSFs have been demonstrated for accurate recording of neural activities that exhibit sufficient spatiotemporal sparsity. At the same time, fluorescence fluctuations and a low SNR in increased depths may cause reconstruction defects to extract more densely packed cellular signals beyond neural spikes. In this regard, we optimize the system performance by developing hybrid point-spread functions (hPSFs) to address the uniformity of the SNR and practical alignment in a customized system, which merge the advantage of both numerical and experimental results, essential for optimum organoid reconstruction. Achieving these advances, in this work, we introduce a custom-built hPSF-FLFM system for fast, volumetric, and high-resolution imaging of entire organoids. In particular, we demonstrate the 3D visualization of the impact of extracellular physical cues on human induced pluripotent stem cells-derived colon organoids (hCOs). The system offers cellular, milliseconds spatiotemporal details of whole-organoid dynamic changes spanning hundreds of micrometers in all three dimensions in instantaneous response to extracellular cues such as osmotic stresses and mechanical forces. We expect the easy adaptability to standard epifluorescence protocols of hPSF-FLFM and its cost-efficient scalability to facilitate the approach to the wide variability of organoid model systems. We anticipate the light-field method to provide a promising avenue to explore spatiotemporal-challenging cellular responses in a broad range of organoid research.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

Moreover, the various components may be in communication via wireless and/or hardwire or other desirable and available communication means, systems, and hardware. Moreover, various components and modules may be substituted with other modules or components that provide similar functions.

An example light-field microscopy system includes a light-field microscope, and an image processing system configured to receive images from the light-field microscope and perform a hybrid point-spread function (PSF) operation using a hybrid point-spread function that comprises numerical profiles that are adjusted by experimental positions and experimentally recorded PSF.

In the light-field microscopy system, the experimentally recorded PSF may be obtained by imaging a first sample of size X (e.g., single-layer sparse sample, e.g., 2-μm fluorescent beads) across a depth range at least 10 times that of size X (e.g., ±40 μm).

In the light-field microscopy system, the light-field microscope may comprise a Fourier light-field microscope.

In the light-field microscopy system, the light-field microscope may include an epifluorescence microscopy unit comprising an objective lens, tube lens, and camera; and a light-field acquisition module coupled to the epifluorescence microscopy unit, the light-field acquisition module comprising a Fourier lens (FL) and microlens array (MLA).

In the light-field microscopy system, the light-field microscope and image processing system may be optimized for organoid imaging.

In the light-field microscopy system, the light-field microscope and image processing system may be configured for millisecond-scale spatiotemporal characterization of a sample.

In the light-field microscopy system, the light-field microscope and image processing system may be configured for millisecond-scale spatiotemporal characterization having an imaging span of between 900 μm×900 μm×200 μm in the x, y, and z axis, respectively.

The light-field microscopy system may include a motor-controlled mechanical loading module.

A method to process an image may include receiving images from a light-field microscope; performing a hybrid point-spread function (PSF) operation using a hybrid point-spread function that comprises numerical profiles that are adjusted by experimental positions an experimentally recorded PSF.

In the method, the hybrid point-spread function may be generated by reconstructing an experimentally measured PSF; reconstructing a numerically simulated PSF; generating sub-PSF of the experimentally measured PSF by cropping image elements from the experimentally measured PSF; generating sub-PSF of the numerically simulated PSF by cropping image elements from the numerically simulated PSF; interpolating the sub-PSFs of the experimentally measured PSF and the numerically simulated PSF; fitting (i) positions of the sub-PSF of the experimentally measured PSF and (ii) positions of the sub-PSF of the numerically simulated PSF; and generating the hybrid point-spread function using the fitted positions.

A non-transitory computer-readable medium may have instructions stored thereon, wherein execution of the instructions by a processor causes the processor to perform any of the methods described herein.

A non-transitory computer-readable medium may have instructions stored thereon, wherein execution of the instructions by a processor causes the processor to perform operations for any of the systems described herein.

A light-field microscopy system may include a light-field microscope; and an image processing system configured to receive images from the light-field microscope and perform a hybrid point-spread function (PSF) operation using a hybrid point-spread function that comprises numerical profiles that is adjusted by experimental positions acquired from an experimentally recorded PSF.

In the light-field microscopy system, the experimentally recorded PSF may be obtained by imaging a first sample of size X (e.g., single-layer sparse sample, e.g., 2-μm fluorescent beads) across a depth range at least 10 times that of size X (e.g., ±40 μm).

In the light-field microscopy system, the light-field microscope may include a Fourier light-field microscope.

In the light-field microscopy system, the light-field microscope may include an epifluorescence microscopy unit comprising an objective lens, tube lens, and camera; and a light-field acquisition module coupled to the epifluorescence microscopy unit, the light-field acquisition module comprising a Fourier lens (FL) and microlens array (MLA).

In the light-field microscopy system, the MLA may include a plurality of microlenses in an mx n array. In some aspects, m may equal n. M and/or m may equal 3 While illustrated herein as 3×3 or 9×9 arrays, other array configurations are possible, including of different shapes or dimensions.

The microlens array may have an orthogonal configuration. Each microlens of the MLA may have a square profile. The light-field acquisition module may include a filter array comprising a plurality of microfilters. The MLA may be between the Fourier lens and the filter array in the light path. Each microfilter in the filter array may correspond to at least one of the microlenses in the MLA. The number of microfilters in the filter array may correspond to the number of microlenses in the MLA. In the light-field microscopy system, a first microfilter of the microfilters may filter light of a first wavelength, and a second microfilter of the microfilters may filter light of a second wavelength different from the first wavelength.

In the light-field microscopy system, the MLA may be removable and replaceable. In the light-field microscopy system, the filter array may be removable and replaceable. In the light-field microscopy system, the light-field microscope and image processing system may be optimized for organoid imaging.

In the light-field microscopy system, the light-field microscope and image processing system may be configured for millisecond-scale, single cellular resolution spatiotemporal characterization of a sample. In the light-field microscopy system, the light-field microscope and image processing system may be configured for millisecond-scale spatiotemporal characterization having an imaging span of between 900 μm×900 μm×200 μm in the x, y, and z axis, respectively. The light-field microscopy system may include a motor-controlled mechanical loading module. A method to process an image may include receiving images from a light-field microscope; and performing a hybrid point-spread function (PSF) operation using a hybrid point-spread function that comprises numerical profiles that is adjusted by experimental positions acquired from an experimentally recorded PSF.

In the method, the hybrid point-spread function may be generated by interpolating the experimentally measured PSF and the numerically simulated PSF; fitting (i) positions of the interpolated experimentally measured PSF and (ii) positions of the interpolated numerically simulated PSF; generating sub-PSF of the interpolated numerically simulated PSF by cropping image elements from the numerically simulated PSF round the fitted positions; generating the interpolated hybrid point-spread function by substituting the interpolated sub-PSF of the numerically simulated PSF into the interpolated experimental recorded PSF using the fitted positions; and generating the hybrid point-spread function by binning the interpolated hybrid point-spread function.

A method to process an image may include receiving images of an object from a first channel of a light-field microscope, the first channel carrying data corresponding to light of a first wavelength, and simultaneously receiving images of the object from a second channel of the light field microscope, the second channel carrying data corresponding to light of a second wavelength; applying a first hybrid point-spread function (PSF) operation to the data of the first channel using a hybrid point-spread function that comprises numerical profiles that are adjusted by experimental positions acquired from an experimentally recorded PSF; and applying a second hybrid point-spread function (PSF) operation to the data of the second channel using a hybrid point-spread function that comprises numerical profiles that is adjusted by experimental positions acquired from an experimentally recorded PSF.

In the method, the first hybrid point-spread function may be generated by interpolating the experimentally measured PSF and the numerically simulated PSF of the first channel; fitting (i) positions of the interpolated experimentally measured PSF and (ii) positions of the interpolated numerically simulated PSF of the first channel; generating sub-PSF of the interpolated numerically simulated PSF by cropping image elements from the numerically simulated PSF round the fitted positions of the first channel; generating the interpolated hybrid point-spread function by substituting the interpolated sub-PSF of the numerically simulated PSF into the interpolated experimental recorded PSF using the fitted positions of the first channel; and generating the hybrid point-spread function by binning the interpolated hybrid point-spread function of the first channel; and the second hybrid point-spread function may be generated by interpolating the experimentally measured PSF and the numerically simulated PSF of the second channel; fitting (i) positions of the interpolated experimentally measured PSF and (ii) positions of the interpolated numerically simulated PSF of the second channel; generating sub-PSF of the interpolated numerically simulated PSF by cropping image elements from the numerically simulated PSF round the fitted positions of the second channel; generating the interpolated hybrid point-spread function by substituting the interpolated sub-PSF of the numerically simulated PSF into the interpolated experimental recorded PSF using the fitted positions of the second channel; and generating the hybrid point-spread function by binning the interpolated hybrid point-spread function of the second channel.

In the method, the first channel may correspond to a first color, and the second channel corresponds to a second color. In the method, the first wavelength and the second wavelength may be produced by passing light from the object through a microfilter array comprising an array of microfilters, wherein a first number of microfilters in the microfilter array correspond to the first wavelength and a second number of microfilters in the microfilter array correspond to the second wavelength. A non-transitory computer-readable medium may have instructions stored thereon, wherein execution of the instructions by a processor causes the processor to perform the methods described herein.

A system for processing images in microscopy may include a memory comprising executable instructions; a processor configured to execute the executable instructions and cause the system to perform the method described herein.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

As discussed herein, a “subject” may be any applicable human, animal, or other organism, living or dead, or other biological or molecular structure or chemical environment, and may relate to particular components of the subject, for instance specific tissues or fluids of a subject (e.g., human tissue in a particular area of the body of a living subject), which may be in a particular location of the subject, referred to herein as an “area of interest” or a “region of interest.”

While various embodiments of the present invention have been described above, it should be understood that they have been presented by way of example only, and not limitation. It will be apparent to persons skilled in the relevant art that various changes in form and detail can be made therein without departing from the spirit and scope of the present invention. Thus, the breadth and scope of the present invention should not be limited by any of the above-described exemplary embodiments, but should be defined only in accordance with the following claims and their equivalents.

1. A light-field microscopy system comprising:
a light-field microscope; and
an image processing system configured to receive images from the light-field microscope and perform a hybrid point-spread function (PSF) operation using a hybrid point-spread function that comprises numerical profiles that is adjusted by experimental positions acquired from an experimentally recorded PSF.

2. The light-field microscopy system of claim 1, wherein the experimentally recorded PSF is obtained by imaging a first sample of size X (e.g., single-layer sparse sample, e.g., 2-μm fluorescent beads) across a depth range at least 10 times that of size X (e.g., ±40 μm).

3. The light-field microscopy system of claim 1, wherein the light-field microscope comprises a Fourier light-field microscope.

4. The light-field microscopy system of claim 1, wherein the light-field microscope comprises:
an epifluorescence microscopy unit comprising objective lens, tube lens, and camera; and
a light-field acquisition module coupled to the epifluorescence microscopy unit, the light-field acquisition module comprising Fourier lens (FL) and microlens array (MLA).

5. The light field microscopy system of claim 4, wherein the MLA comprises a plurality of microlenses in an m×n array.

6. The light field microscopy system of claim 5, wherein m=n.

7. The light field microscopy system of claim 6, where m=n=3.

8. The light field microscopy system of claim 4, wherein the microlens array has an orthogonol configuration.

9. The light field microscopy system of claim 4, wherein each microlens of the MLA has a square profile.

10. The light field microscopy system of claim 4, the light-field acquisition module further comprising a filter array comprising a plurality of microfilters.

11. The light field microscopy system of claim 10, wherein the MLA is between the Fourier lens and the filter array in the light path.

12. The light field microscopy system of claim 10, wherein each microfilter in the filter array corresponds to at least one of the microlenses in the MLA.

13. The light field microscopy system of claim 10, wherein the number of microfilters in the filter array corresponds to the number of microlenses in the MLA.

14. The light field microscopy system of claim 10, wherein a first microfilter of the microfilters filters light of a first wavelength and a second microfilter of the microfilters filters light of a second wavelength different from the first wavelength.

15. The light field microscopy system of claim 4, wherein the MLA is removable and replaceable.

16. The light field microscopy system of claim 10, wherein the filter array is removable and replaceable.

17. The light-field microscopy system of claim 1, wherein the light-field microscope and image processing system are optimized for organoid imaging.

18. The light-field microscopy system of claim 1, wherein the light-field microscope and image processing system are configured for millisecond-scale, single cellular resolution spatiotemporal characterization of a sample.

19. (canceled)

20. The light-field microscopy system of claim 1, further comprising a motor-controlled mechanical loading module.

21. A method to process an image comprising:
receiving images from a light-field microscope; and
performing a hybrid point-spread function (PSF) operation using a hybrid point-spread function that comprises numerical profiles that is adjusted by experimental positions acquired from an experimentally recorded PSF,
wherein the hybrid point-spread function is generated by:
interpolating the experimentally measured PSF and the numerically simulated PSF;
fitting (i) positions of the interpolated experimentally measured PSF and (ii) positions of the interpolated numerically simulated PSF;
generate sub-PSF of the interpolated numerically simulated PSF by cropping image elements from the numerically simulated PSF round the fitted positions;
generating the interpolated hybrid point-spread function by substituting the interpolated sub-PSF of the numerically simulated PSF into the interpolated experimental recorded PSF using the fitted positions; and
generating the hybrid point-spread function by binning the interpolated hybrid point-spread function.

22.-28. (canceled)
